(19) United States
(12) Patent Application Publication
(10) Pub. No.: US 2018/0264983 A1
(43) Pub. Date: Sep. 20, 2018

(54) A LOAD CARRIER FOR A VEHICLE

(71) Applicants: Yu-Hao LIN, Victoria (AU); Ya-I HU, Victoria (AU)

(72) Inventors: Yu-Hao LIN, Victoria (AU); Ya-I HU, Victoria (AU)

(21) Appl. No.: 15/761,801

(22) PCT Filed: Sep. 21, 2016
(86) PCT No.: PCT/AU2016/050882

§ 371 Date: Mar. 20, 2018

(30) Foreign Application Priority Data
Sep. 21, 2015 (AU) 2015903849

(51) Int. Cl. B60P 1/54; B60P 3/10; B60R 9/042; B66C 23/16

(52) U.S. Cl. CPC B60P 1/5471; B60P 3/1008; B60R 9/045; B66C 23/166; B60R 9/042

(57) ABSTRACT

A load carrier for a vehicle comprising a vehicle roof supports adapted to carry a load thereon in a consistent vertical orientation; a lifting apparatus for lifting the load from a lower position in the consistent vertical orientation to a raised position at or above the vehicle roof supports; wherein the load is able to be lifted in the consistent vertical orientation and supported in the same consistent vertical orientation.

### FIELD OF THE INVENTION

The present invention relates to a load carrier for a vehicle and in particular in one form to a roof mounted load carrier with integral lifting apparatus for mounting a load on and off a vehicle.

The invention has been developed primarily for use with a motor vehicle and vehicle roof supports including roof rack systems and will be described hereinafter with reference to this application. However, it will be appreciated that the invention is not limited to this particular use.

### BACKGROUND OF THE INVENTION

Carrying loads on vehicles has generally used roof racks in which spaced bars extend across and above the roof of a vehicle and are held by clamps fitting into gutters of the vehicle roof or into holding clamps built into the vehicle between the roof panel and side door panels.

However as shown in FIGS. 2A to 2C and 3A to 3D to load or to unload a large object like a boat requires at least two people. The two people have to lift the boat. Further they need to rotate the boat so as to be suitably arranged relative to the roof carrier. Then the two people must stretch over the vehicle while maintaining the load above head level and reach to place the load on the roof carrier of the vehicle.

Generally that means an element of dropping the load onto the carrier or causing severe stress on lower back while lowering the load which is at a stretch away from you. The load needs to be manipulated further by sliding the load into a central vehicle position and then climbing all over the vehicle to tie the loads to the vehicle or roof carrier.

It can be seen that there are substantial risks to the people undertaking the lift, as well as risks to the load and risks of damage to the vehicle.

Referring to FIGS. 3A to 3D there is clearly more danger in unloading a large object like a boat. Firstly the two people must detach the boat from the carrier. Secondly they must stretch over the vehicle and lift the boat off the carrier. As this is difficult, it is more likely the boat is dragged over the roof carrier damaging the boat and the roof carrier. Then the two people need to lift and to rotate the boat so as lower the boat to the ground. This again is likely to involve damage to the two people undertaking the unloading and to result in the boat being at least partially dropped to the ground.

Generally that means there is climbing all over the vehicle to untie the loads to the vehicle or roof carrier, sliding the load into a edge of vehicle position and an element of dropping the load onto the people trying to unload and onto the ground.

Again it can be seen that there are substantial risks to the people undertaking the unloading, as well as risks to the load and risks of damage to the vehicle.

It can be seen that known prior art carriers have the problems of:
a) ineffectiveness
b) Difficulty in transport
c) Bulkiness
d) Difficulty in use
e) Requirement of more than the driver of the vehicle
f) Requirements for separate transport of any aids to the unloading location from the loading location and difficulty in such transport
g) the inappropriateness of current lifting aids

The present invention seeks to provide a load carrier for a vehicle, which will overcome or substantially ameliorate at least one or more of the deficiencies of the prior art, or to at least provide a viable alternative.

It is to be understood that, if any prior art information is referred to herein, such reference does not constitute an admission that the information forms part of the common general knowledge in the art, in Australia or any other country.

### SUMMARY OF THE INVENTION

According to a first aspect of the present invention, a load carrier for a vehicle comprising a vehicle roof supports adapted to carry a load thereon in a consistent vertical orientation; a lifting apparatus for lifting the load from a lower position in the consistent vertical orientation to a raised position at or above the vehicle roof supports; wherein the load is able to be lifted in the consistent vertical orientation and supported in the same consistent vertical orientation.

Preferably the lifting apparatus has a lift mount, wherein the lift mount is able to proceed from the lower position and extend above the vehicle roof supports to a raised position to allow mounting of the load is able to be lifted in the consistent vertical orientation and supported in the same consistent vertical orientation

In one form the lifting mount has a lifting arm, wherein the lifting arm is able to pivot around a pivot support and rotate from a lower pivot position to a high pivot position above the raised position wherein the load is able to be lifted in the consistent vertical orientation and supported in the same consistent vertical orientation.

Preferably the lifting mount has lifting legs, wherein the lifting legs are able to extend from a leg extension support and extend from a lower splayed leg extension position to a high less splayed leg extension position above the raised position wherein the load is able to be lifted in the consistent vertical orientation and supported in the same consistent vertical orientation.

The lifting apparatus can include a lift cable, wherein the lift cable is able to extend from a lift cable support and extend from a lower cable extension position to a high cable extension position above the raised position wherein the load is able to be lifted in the consistent vertical orientation and supported in the same consistent vertical orientation.

In one form the lift mount is mountable on the ground. However the lift mount can be mounted on the ground on wheels or castors.

In another form the lift mount is mounted on the vehicle roof supports.

Preferably the lift mount supports a lift tray upon which the load can be mounted while on the ground, and the load is able to be lifted in the consistent vertical orientation and supported in the same consistent vertical orientation.

The lift tray can therefore in one form be supportable on the vehicle roof supports. The lift tray could form at least part of the vehicle roof supports.

Preferably the lift mount includes a foldable mount structure having a releasable locking means for allowing locking of the foldable mount structure in an operating condition, and release to a folded storage position upon release of the locking means.

The lifting mount can have a lifting arm which is pivotally mounted on pivot support separate to the vehicle and movable in relation to a vehicle. The lifting mount can have a lifting arm which is pivotally mounted on pivot support mounted to the vehicle and movable from a storage position on the vehicle to an operative position on the vehicle. Preferably the storage position is alongside the vehicle roof supports.

In one form the lifting arm in an operative position pivots in a first direction from the pivot support and the lifting arm pivots in a second direction separate to the first direction to a storage position which is alongside the vehicle roof supports.

The lift tray can form at least part of the vehicle roof support and is supportable by a vehicle and the lifting arm extends from pivot support on one side of the lift tray and extending beyond the opposite side of the lift tray on the other side of the vehicle allowing the lifting arm to extend alongside the sides of the vehicle and engage the ground to self-support the lift tray and allow the lift tray to receive a load in a consistent vertical orientation and allow the lifting arm to lift the load from the lower position in the consistent vertical orientation to the raised position at or above the vehicle roof and to be supported on the vehicle in the same consistent vertical orientation.

The lifting arm can include a lift cable extending from the lift tray to a at or near a top portion of the pivot arm and down through a pivot brace rigidly connected at or near a lower portion of the pivot arm and extending at an angle thereto away from the vehicle in use, wherein the lift cable is able to be used from one side of the vehicle to lift a load on the lift tray on the other side of the vehicle to the raised position at or above the vehicle roof and to be supported on the vehicle in the same consistent vertical orientation.

Preferably the lifting mount has lifting legs, wherein the lifting legs are extendable from a leg extension support mountable to the vehicle.

However in another form the lifting mount has lifting legs, wherein the lifting legs are extendable from a leg extension support and separately supportable in relation to a vehicle from a storage position to an operative position.

The load carrier for a vehicle can have a lift tray supported by the lifting legs wherein the lift tray forms at least part of the vehicle roof supports. The lifting legs can use a scissor lifting arrangement, a hydraulic lifting arrangement, a telescopic lifting arrangement or other mechanical means.

Preferably the lift tray forms at least part of the vehicle roof supports and is supportable by a vehicle and the lifting legs extend from leg extension support on opposite sides of the lift tray allowing the lifting legs to extend alongside the sides of the vehicle and engage the ground to self-support the lift tray and allow the vehicle to move relative the load carrier and the lifting legs to retract and lower the lift tray to the lower position to receive a load in a consistent vertical orientation and allow the lifting legs to lift the load from the lower position in the consistent vertical orientation to the raised position at or above the vehicle roof and allow the vehicle to move relative the load carrier to allow the load to be lifted in the consistent vertical orientation and supported on the vehicle in the same consistent vertical orientation.

The lift tray could be supported on the vehicle and the lift legs supportable in relation to the vehicle in a storage position alongside the lateral sides of the lift tray extending collinear with the sides of the vehicle and movable substantially to an operative position in spaced planar arrangements extending along the sides of the vehicle.

Preferably the lifting apparatus in one form, can include a lift cable has the lift cable mounted on a lift cable support separate to the vehicle and movable in relation to a vehicle.

Preferably the lifting apparatus could include a lift cable has the lift cable mounted on a lift cable support mounted to the vehicle and movable from a storage position on the vehicle to an operative position on the vehicle.

Preferably a lift pulley is provided for aiding the user to lift load with the lifting apparatus wherein the lift pulley extends from an upper part of the lift arm of the lifting apparatus and includes a pulley arrangement to provide a mechanical aid.

The invention also provides a method of lifting a load from a lower position to a raised position above a vehicle roof supports to allow mounting of the load to be lifted in a consistent vertical orientation and supported in the same consistent vertical orientation including the steps of:
a) Orientating a load on a lift tray in a consistent vertical orientation; b) Providing a lifting apparatus for lifting the load from a lower position in the consistent vertical orientation to a raised position at or above the vehicle roof supports.

The method can include having the lifting apparatus interacting with the vehicle to assist the lifting operation.

The method can further include the lifting apparatus interacting with the vehicle includes the at least part of the lifting apparatus mountable on the vehicle to assist the lifting operation.

The method can further include the lifting apparatus interacting with the vehicle includes the at least part of the lifting apparatus mountable on the vehicle to assist the lifting operation is provided by forming a leveraging base to allow the load to be counterbalanced by the vehicle.

The method can further include the lifting apparatus interacting with the vehicle includes the at least part of the lifting apparatus mountable on the vehicle to assist the lifting operation is provided by forming a pivoting base to allow the load to be pivot around a pivot point on the vehicle.

The method can further include having the lifting apparatus interacting with the vehicle and supportable in relation to the vehicle from a storage position to an operative position.

The method can further include having the lifting apparatus foldable to a storage position alongside the vehicle roof supports.

In one form the invention provides a load carrier for vehicle including any one or more of the following features:
a) a lifting apparatus;
b) A lift mount;
c) A lifting arm;
d) Lifting legs;
e) Lift cable;
f) Lift cable support;
g) Lift tray;
h) Mechanical aid;
i) Hydraulic means;
j) wherein the load carrier for a vehicle can be used substantially singled-handedly to improve in any one or more of the following:
   i) Orientating a load on a lift tray in a consistent vertical orientation;
   ii) Providing a lifting apparatus for lifting the load from a lower position in the consistent vertical orientation to a raised position at or above the vehicle roof supports.

It can be seen that the invention of load carrier for vehicle provides one or more of the following benefits of;
a) Ease of use;
b) Single person use;
c) Not requiring rotation of load onto or off the roof of the vehicle;
d) Apparatus transportable with vehicle;
e) Protection of load in the loading/unloading procedure

The invention in various forms includes a load carrier for a vehicle comprising a vehicle roof supports adapted to carry a load thereon in a consistent vertical orientation; a lifting apparatus for lifting the load from a lower unloaded position in the consistent vertical orientation to a raised loaded position at or above the vehicle roof supports; a lifting frame for supporting the load when in the loaded position from the unloaded position; and a lifting frame movement means which lifts the lifting frame between the loaded position and the unloaded position wherein the load is able to be lifted in the consistent vertical orientation and supported in the same consistent vertical orientation.

The lifting apparatus can be transportable with the vehicle.

The lifting apparatus can be mounted to the vehicle so as to be transportable with the vehicle and to be operable as a lifting apparatus while mounted to the vehicle.

Preferably the lifting frame movement means is provided by one or more of: a) a lifting mount having a lifting arm.
b) the lifting frame movement means is provided by a lifting mount having lifting legs.
c) the lifting frame movement means is provided by a lifting apparatus includes a lift cable.
d) the lifting frame movement means is provided by a lift mount is mountable on the ground.
e) the lifting frame movement means is provided by a lift mount which is mountable on the ground on wheels or castors.
f) the lifting frame movement means is provided by lift mount which is mounted on the vehicle roof supports.
g) the lifting frame movement means is provided by a lift mount which includes a foldable mount structure having a releasable locking means for allowing locking of the foldable mount structure in an operating condition, and release to a folded storage position upon release of the locking means
h) the lifting frame movement means is provided by a lifting arm is pivotally mounted on pivot support separate to the vehicle and movable in relation to a vehicle.
i) the lifting frame movement means is provided by lifting legs which use a scissor lifting arrangement.
j) the lifting frame movement means is provided by lifting legs which use a hydraulic lifting arrangement.
k) the lifting frame movement means is provided by lifting legs which use a telescopic lifting arrangement
l) the lifting frame movement means is provided by lifting legs which are operable to retract and lower the lift tray to the lower position to receive a load in a consistent vertical orientation and allow the lifting legs to lift the load from the lower position in the consistent vertical orientation to the raised position at or above the vehicle roof and allow the vehicle to move relative the load carrier to allow the load to be lifted in the consistent vertical orientation and supported on the vehicle in the same consistent vertical orientation.
m) the lifting frame movement means is provided by a lifting apparatus including a lift cable has the lift cable mounted on a lift cable support separate to the vehicle and movable in relation to a vehicle.
n) the lifting frame movement means is provided by a lift pulley for aiding the user to lift load with the lifting apparatus wherein the lift pulley extends to an upper part of the lift arm of the lifting apparatus and includes a pulley arrangement to provide a mechanical aid.
o) the lifting frame movement means is provided by a lift slide and lift pulley for aiding the user to lift a load with the lifting apparatus wherein the lift slide is extendable from a transport mode to a loading and unloading mode and extends from the vehicle roof mounts towards the ground adjacent to the vehicle and the lift pulley mounted on the vehicle and attached to the lifting frame allows selective control of the lifting frame to slide from a loaded position on the vehicle roof mounts along the lift slide to an unloaded position adjacent the vehicle.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 is a diagrammatic view of a load carrier for vehicle in accordance with a general preferred embodiment of the present invention;

FIGS. 2A, 2B, and 2C are prior art means of loading a load onto a roof carrier a vehicle;

FIGS. 3A, 3B, 3C and 3D are prior art means of unloading a load onto a roof carrier a vehicle;

FIGS. 4 and 5 are diagrammatic views of a load carrier for vehicle in accordance with a first and a second preferred embodiment of the present invention using a separate lift means and lift tray;

FIGS. 6 to 11 are various diagrammatic views of the first preferred embodiment of FIG. 4 including a side view in FIG. 6 and various stages A, B, C and D of storage to partially unfolded in FIGS. 7 and 8, and explanatory diagrams of use in FIGS. 9, 10 and 11;

FIGS. 12 to 17 are various diagrammatic views of the second preferred embodiment of FIG. 5 including a perspective view in FIG. 13 and various stages A, B, C, D, E and F of storage to partially unfolded forms in FIG. 12, and explanatory diagrams of use in FIGS. 14 to 17;

FIGS. 18 and 19 are diagrammatic views of a load carrier for vehicle in accordance with a third and fourth preferred embodiment of the present invention using a roof mounted pivoting lift means and lift tray;

FIGS. 20 to 25 are various diagrammatic views of the third preferred embodiment of FIG. 18 including a perspective view in FIG. 20 and various stages A, B, C, D, E, F and G of storage to partially unfolded in FIG. 21, and explanatory diagrams of use in FIGS. 22 to 25;

FIGS. 26 to 31 are various diagrammatic views of the fourth preferred embodiment of FIG. 19 including a perspective view in FIG. 26 and various stages A, B, and C and D of storage to partially unfolded in FIG. 27 and explanatory diagrams of use in FIGS. 28 to 31;

FIGS. 32 and 33 are diagrammatic views of a load carrier for vehicle in accordance with a fifth and sixth preferred embodiment of the present invention using an over roof leg extending lift means and lift tray;

FIGS. 34 to 43 are various diagrammatic views of the fifth preferred embodiment of FIG. 32 including a perspective views in FIG. 34, 35 and explanatory diagrams of use in FIGS. 36 to 42 and explanatory storage on vehicle in FIG. 43;

FIGS. 44 to 54 are various diagrammatic views of the fifth preferred embodiment of FIG. 33 including a perspective views in FIG. 44, and explanatory diagrams of use in FIGS. 45 to 53 and explanatory storage on vehicle in FIG. 54; and

FIGS. 55 to 57 are various diagrammatic views of the sixth preferred embodiment of using a slide means for the lift tray.

### DESCRIPTION OF PREFERRED EMBODIMENTS

It should be noted in the following description that like or the same reference numerals in different embodiments denote the same or similar features.

There are three distinct versions of the load carrier for vehicle detailed hereinafter which can be categorized as:
a) Overhanging version
b) Vehicle mounted version; and
c) Vehicle mountable version.

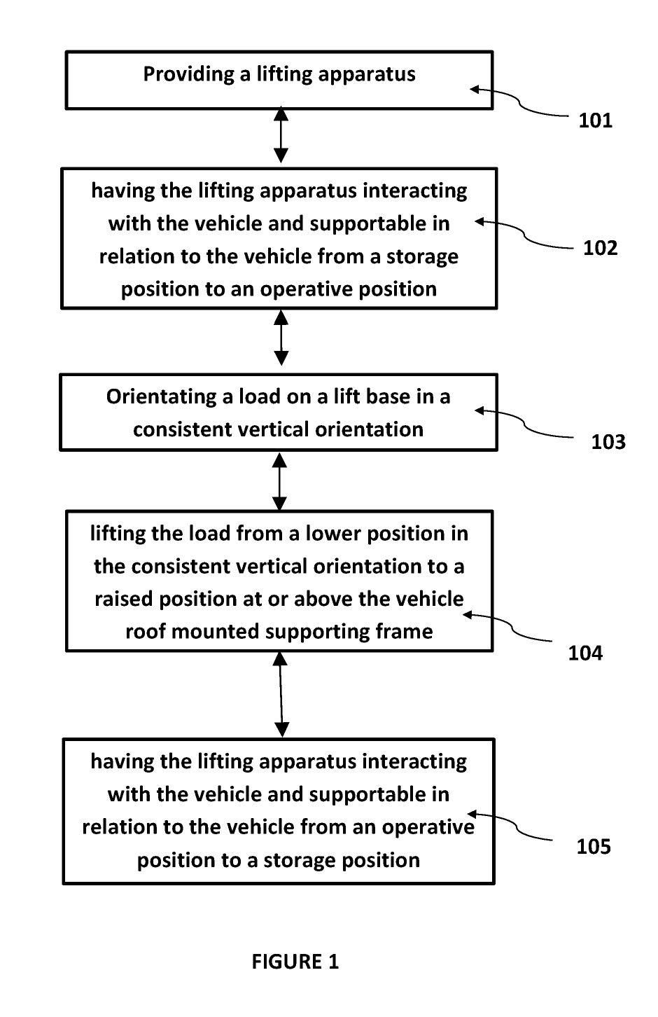

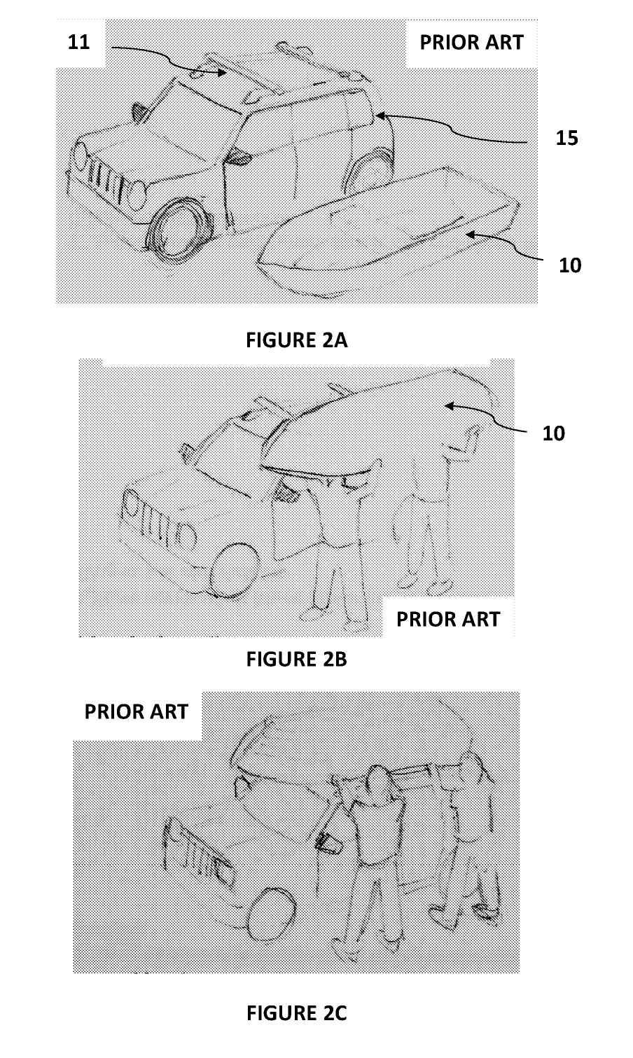

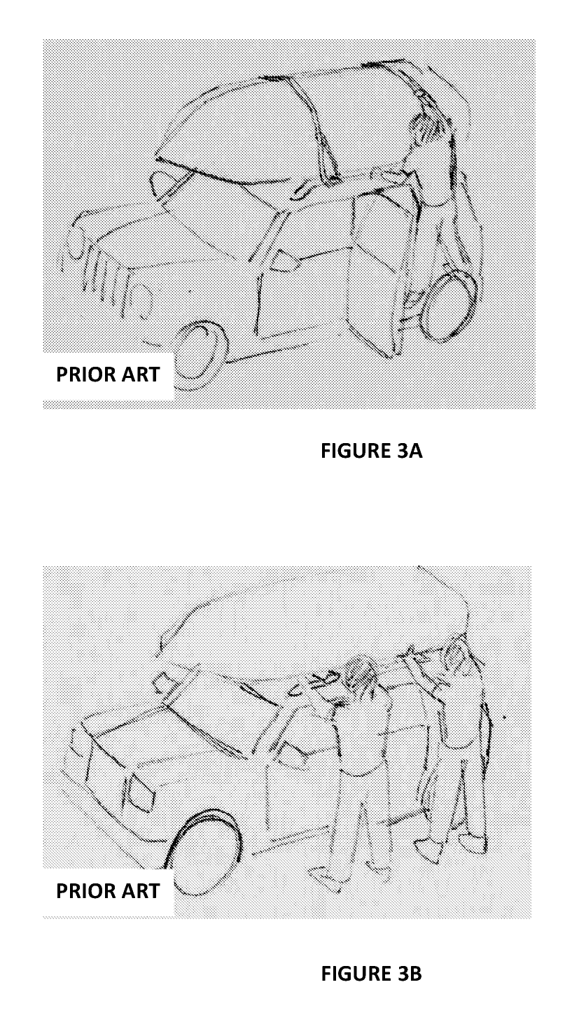

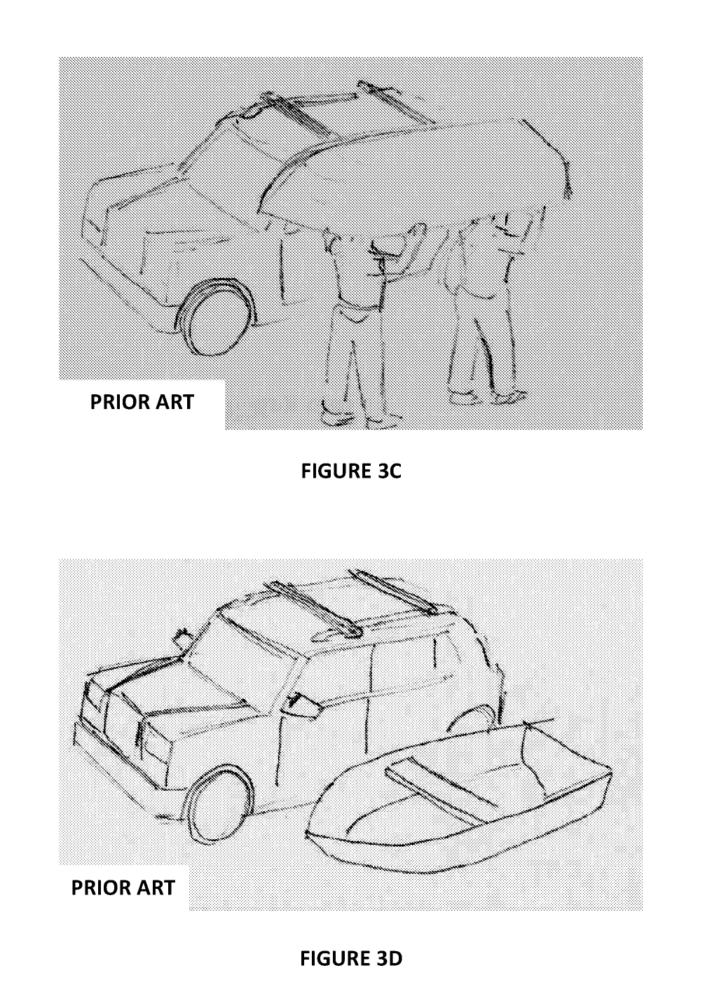

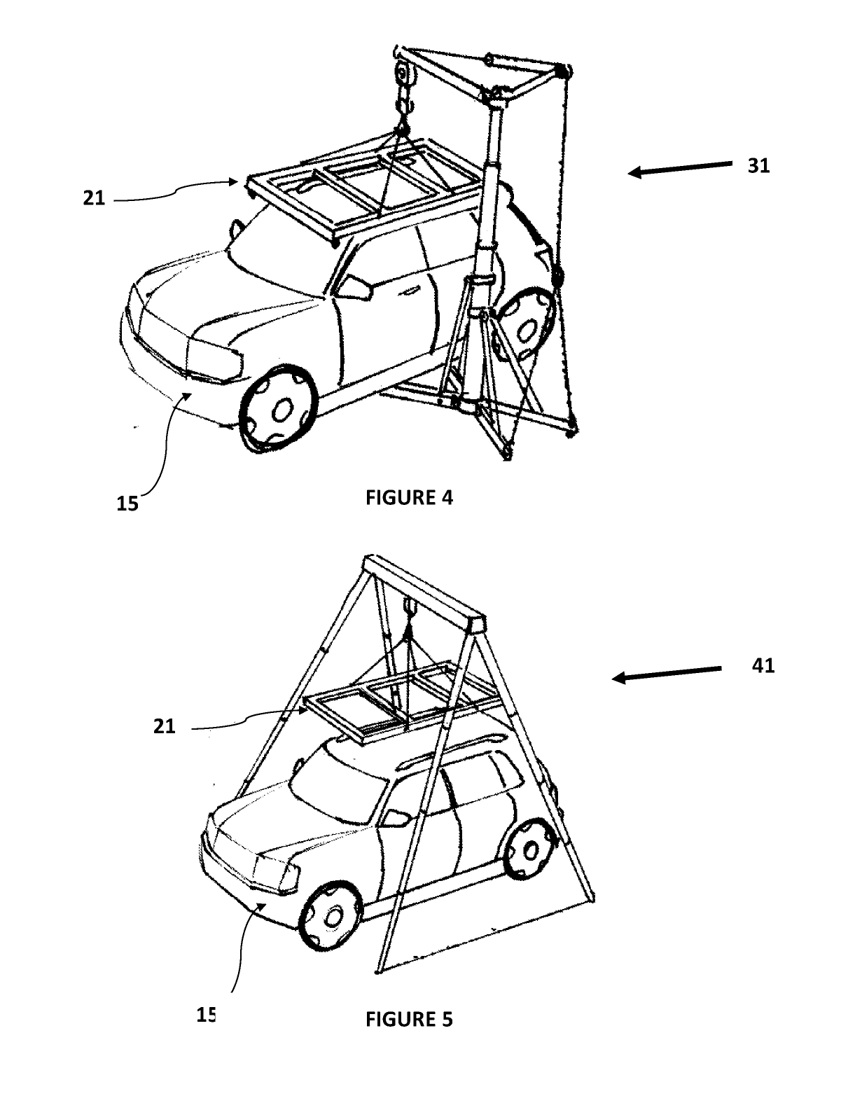

Referring to FIG. 1 it can be seen that each version of a load carrier for a vehicle of the invention allows the steps of step 101 of providing a lifting apparatus. This is followed by step 102 of having the lifting apparatus interacting with the vehicle and supportable in relation to the vehicle from a storage position to an operative position. Then there is step 103 of orientating a load on a lift base in a consistent vertical orientation. It is then possible to proceed to step 104 of lifting the load from a lower position in the consistent vertical orientation to a raised position at or above the vehicle roof mounted supporting frame. A great advantage of the invention is from step 105 of having the lifting apparatus interacting with the vehicle and supportable in relation to the vehicle from an operative position to a storage position.

It should be noted that the steps can be undertaken in reverse order and each step can proceed to the next step or recede to the previous step.

Version a)

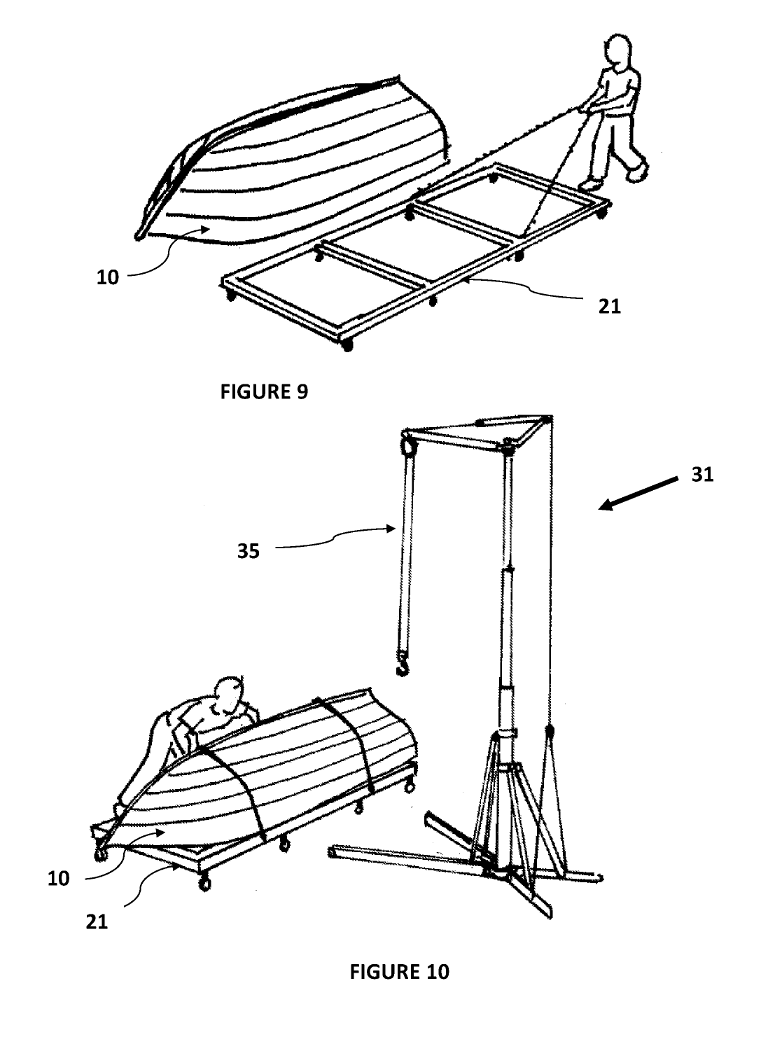

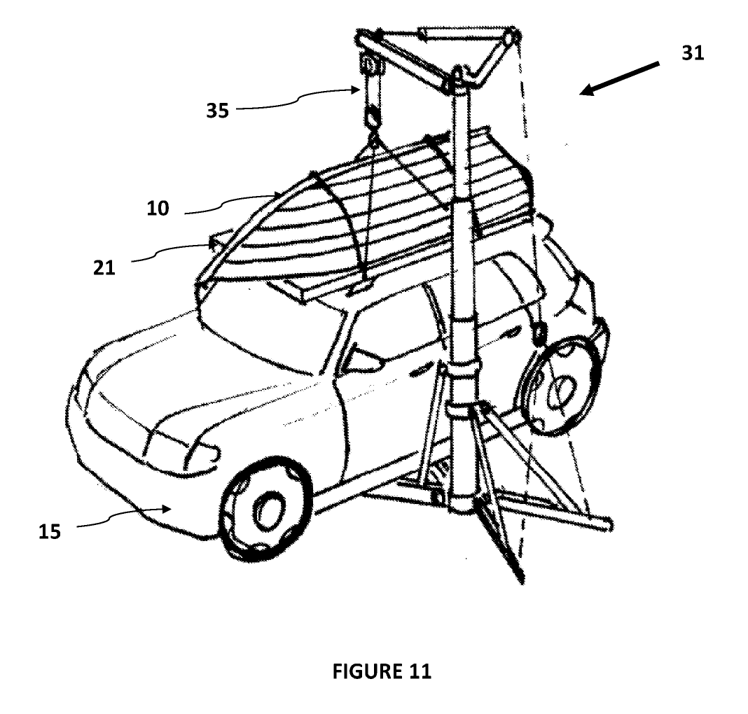

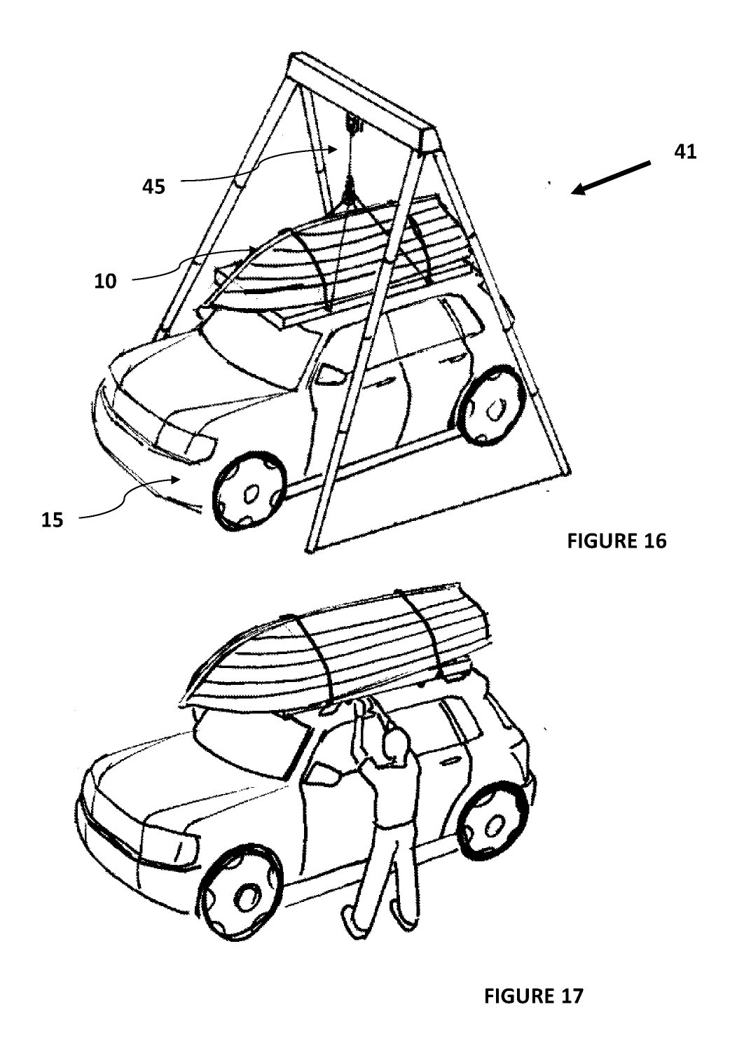

Referring to FIGS. 4 to 17 there is shown two forms of overhanging version of load carriers. The first uses a ground set-up hoist 31 while the second uses a ground set-up gantry system 41. Both of these systems allow the user 16 to be able to alone use the load carrier 31, 41 for loading a load such as a boat 10 onto a vehicle 15. The load carrier 31, 41 comprises a vehicle roof mounted supporting lift tray 21 adapted to carry the load 10 thereon in a consistent vertical orientation. In each there is provided a lifting apparatus 31, 41 for lifting the load 10 from a lower position in the consistent vertical orientation to a raised position at or above the vehicle roof supports 11 wherein the load 10 is able to be lifted in the consistent vertical orientation and supported in the same consistent vertical orientation.

One embodiment of Version a) is the ground set-up hoist lifting version 31 shown in FIGS. 4 and 6 to 11. This has the particular advantage of being movable relative to the vehicle. However it also has the advantage of being formed as a structure that can be transformed from an operative expanded form with structural integrity and capabilities to lift a load onto a vehicle to a storage and reduced form which is readily able to be transported with the load and vehicle and used at the other end of the transport trip to allow demounting of the load.

In the form shown in FIGS. 4 and 6 to 11 the lifting apparatus 31 uses the supporting lift tray 21 to hold the load of the boat 10. The lifting apparatus 31 has an overhanging arm 32 mounted pivotally at connection 32A at the top of a telescopically extendable upright 33 mounted on a ground engaging lift counterweight 39.

The telescopically extendable upright 33 has its structural integrity increased by slidable supporting braces 34 pivotally mounted to the ground engaging counterweight base 39 at one end and at the other end having a circular ring just circumventing the upright sufficient to provide support while allowing sliding motion from an operative expanded form with structural integrity and capabilities to lift a load onto a vehicle to a storage and reduced form.

A lift cable 35 extends over the supporting frame from the end of the overhanging arm 32 distal to the connection to the upright 33. Supporting the end of the overhanging arm 32 is a triangular arrangement including a pivoting crank arm 36 pivotally connected to the top of the upright 33 and extending upwards to an upper support point 37 and has a suspension cable 38 extending from the support point 37 to the lower end of the overhanging arm 32. This support point is retained in position by connection to the lift counterweight 39 comprising the ground engaging counterweight base 39A and a support line 39B extending from the ground engaging counterweight base 39A to the support point 37.

The lift cable 35 such as a rope and shackle pulley extending from the supported end of the overhanging arm 32 can suspend to the rectangular vehicle roof mounted supporting lift tray 21 from the distal end of the lift arm 32.

The lifting apparatus 31 is mounted on a lift counterweight 39 having a ground engaging counterweight base 39A formed from a plurality of spaced ground engaging feet radiating feet to provide stability which feet extend from the upright 33. The engaging counterweight base 39A can be mounted on wheels or castors so as to be movable from a spaced distance from the vehicle 15 to a position under the vehicle while the supporting lift upright 33 extends up alongside the vehicle and the lifting arm 32 overhangs the top of the vehicle 15.

Referring to FIGS. 9 to 11 in use of the lifting apparatus 31 uses the supporting lift tray 21 to hold the load of the boat 10. As shown in FIGS. 9 and 10, the supporting lift tray 21 is mounted on wheels allowing it to be moved to the heavy load of the boat 10 in the transportable orientation. The boat can be edged onto the supporting lift tray 21 by the person 16 alone. The load is then fastened to the frame and as a unit moved to one side of a vehicle 15. The lift cable 35 is attached to the load and manipulated to raise the load to a height greater than the vehicle height.

The ground set-up hoist lifting version 31 is then wheeled to the side of the vehicle and has its legs 39A extend under the vehicle so the overhanging arm 32 can extend over the vehicle 15. The load 10 on the lift tray 21 can then be lowered onto the top of the vehicle 15 by manipulating the cable and pulley of the lift cable 35.

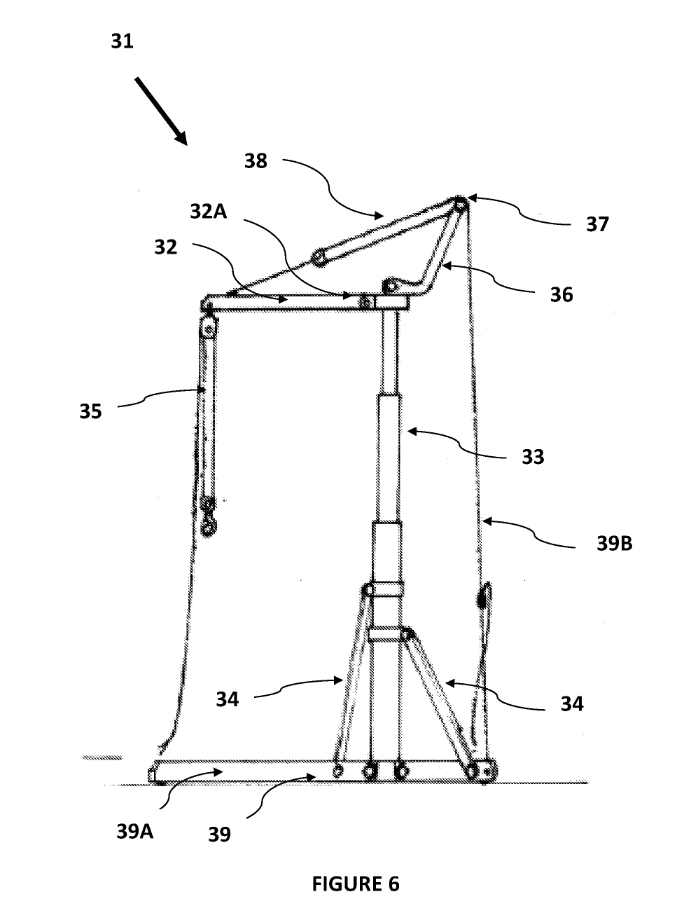

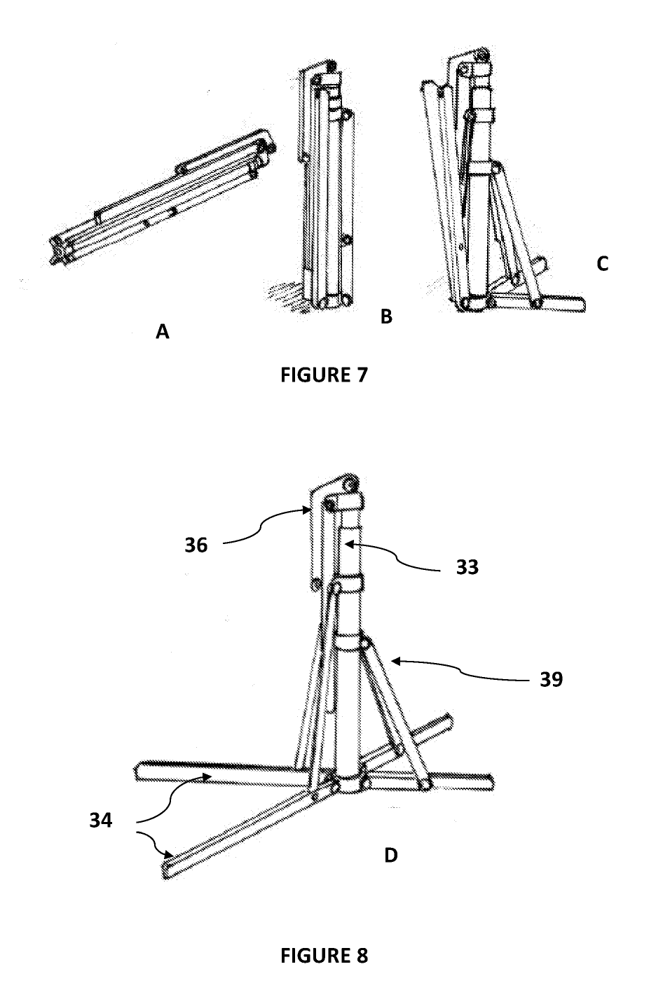

Referring to FIGS. 6, 7 and 8 there is shown how the lifting apparatus 31 can be transformed through various stages back through D to C to B to A from an operative expanded form with structural integrity and capabilities to lift a load onto a vehicle to a storage and reduced form which is readily able to be transported with the load and vehicle and used at the other end of the transport trip to allow demounting of the load. This is achieved by telescopic upright 33 being telescopically reduced and the pivot arm 32 and the crank arm 36 all pivoting in the same direction to extend alongside the reduced height upright 33. The support struts 34 can have their rings move relative to the upright 33 to bring the pivotally connected ground engaging base legs 39A in the form of radial arms pivot around the lower connection to the upright 33 to extend upwardly adjacent to the upright. This results in a small package as shown in A of FIG. 7 connected substantially parallel elongated elements forming an easily transportable package for carriage in the vehicle.

Another embodiment of Version a) is the ground set-up gantry system 41 shown in FIGS. 5 and 12 to 17. This has the particular advantage of the vehicle being movable relative to the gantry system and load. This can allow greater loads. However it also has the advantage of being formed as a structure that can be transformed from an operative expanded form with structural integrity and capabilities to lift a load onto a vehicle to a storage and reduced form which is readily able to be transported with the load and vehicle and used at the other end of the transport trip to allow demounting of the load.

As shown in FIGS. 5 and 12 to 17, the lifting apparatus 41 has a lift cable supported by an overhead gantry bar 42 supported by a plurality of legs 43. The load 10 can be placed on the lift tray 21 when it is on the ground and the lift tray 21 with the load 10 onboard can proceed from the lower position to extend above the vehicle roof supports 11. Therefore the load proceeds to a raised position to allow mounting of the load to be lifted in the consistent vertical orientation and supported in the same consistent vertical orientation.

In particular the lifting apparatus 41 has an overhanging gantry arm 42 which extends between two sets of inverted V arranged telescopic legs 43 held apart by spacing means 44 at the base. A lift cable 45 is suspended from the overhanging arm 42 and has a rope and shackle pulley.

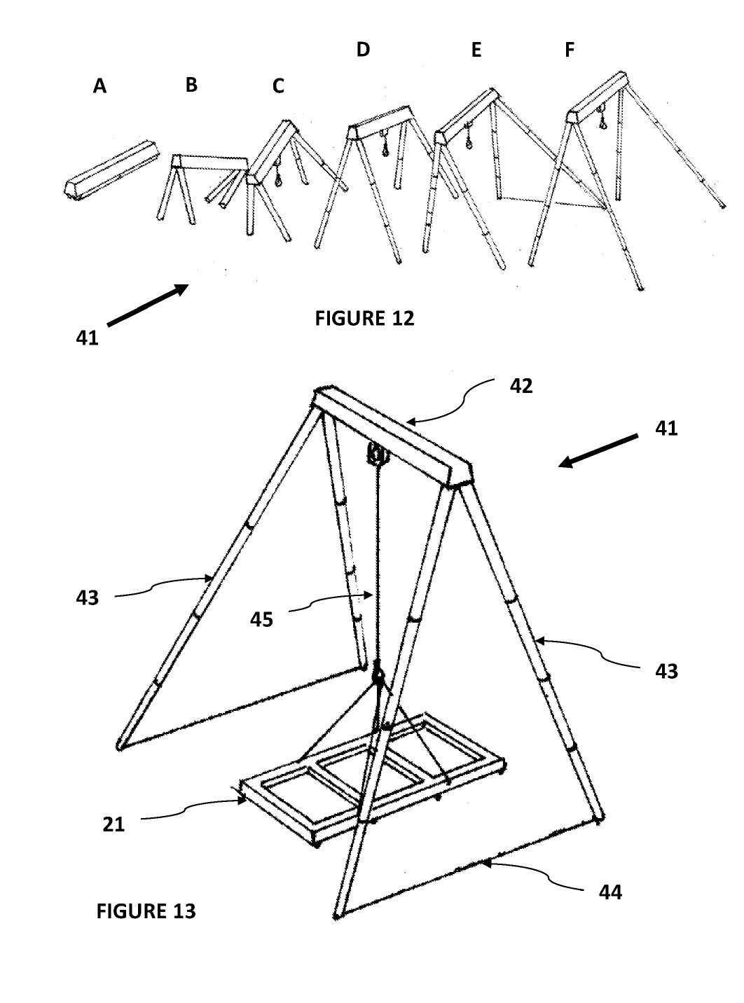

FIG. 12 shows through stages A to B to C to D to E to F how the lifting apparatus 41 can proceed from a storage and reduced form which is readily able to be transported with the load 10 and vehicle 15 and used at the other end of the transport trip to allow demounting of the load to an operative expanded form with structural integrity and capabilities to lift a load onto or off a vehicle. Initially it starts as a small package of connected substantially parallel elongated elements forming an easily transportable package for carriage in the vehicle. The two sets of legs 43 are pivotally mounted to either end of the overhanging arm 42 and can extend from a parallel position to a position at or just beyond 90° and to then splay relative to each other to form a stable base for supporting the overhanging arm 42 in a substantially horizontal position. Each of the telescopic legs can be extended similarly to maintain this horizontal position of the overhanging arm 42 but at a greater height. The legs 43 can be dissimilarly extended to compensate for uneven ground but to still maintain this horizontal position of the overhanging arm 42.

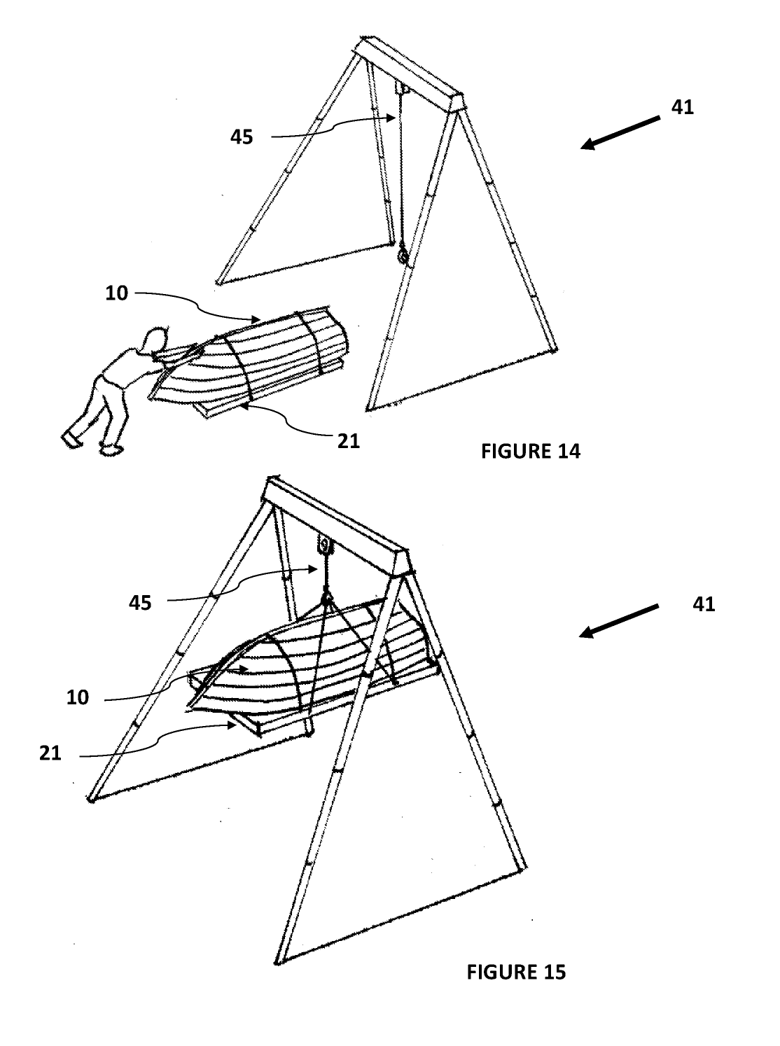

Referring to FIGS. 14 to 17 the ground set-up gantry system 41 can be used by placing and binding the load 10 such as a boat in the fixed orientation to the lift tray 21 and wheeling it into location below the overhanging arm 42. The lift cable 45 suspended from the overhanging arm 42 suspends the lift tray 21 in the form of a rectangular frame and the load 10 in the form of a boat connected thereto from the rope and shackle pulley 45. The lift cable 45 is able to engage ropes supporting the load 10 on the lift tray 21 and through the pulley portion of the lift cable 45 be hoisted into the air above the height of the vehicle 15. By movement of the lifting apparatus 41 relative to the vehicle 15 the load 10 on the vehicle roof supports 11.

Version b)

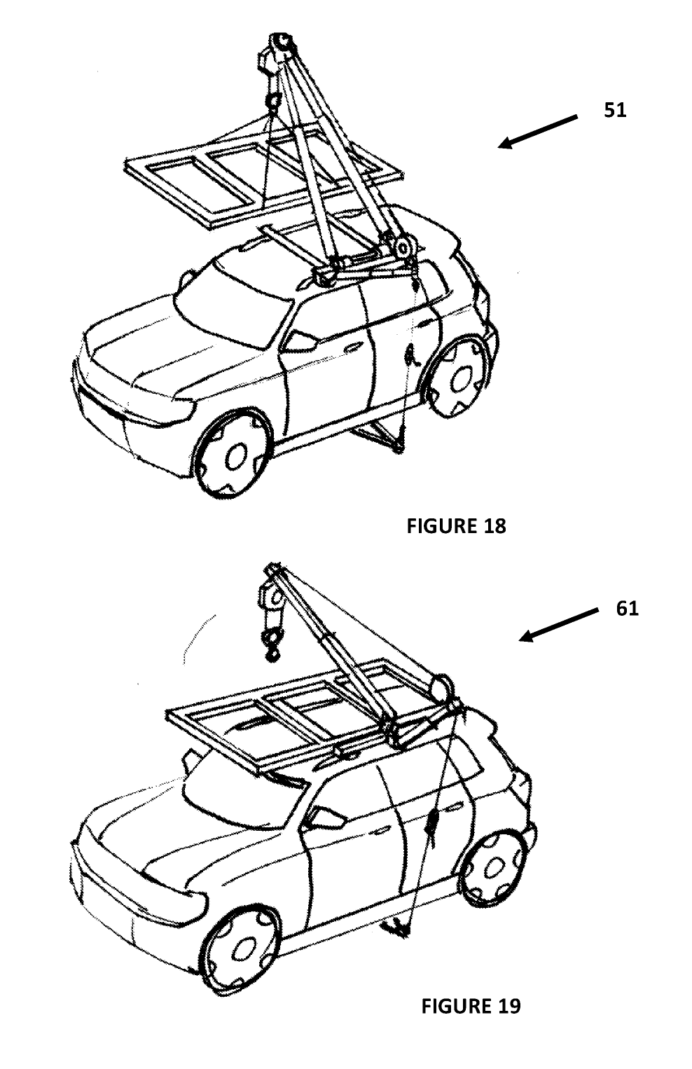

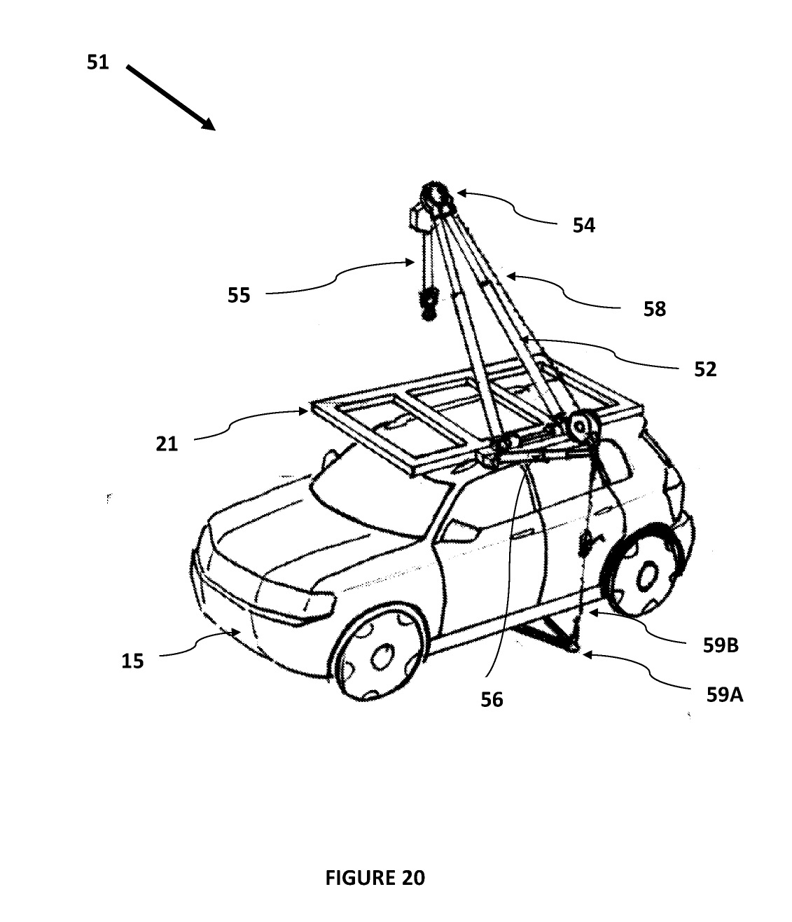

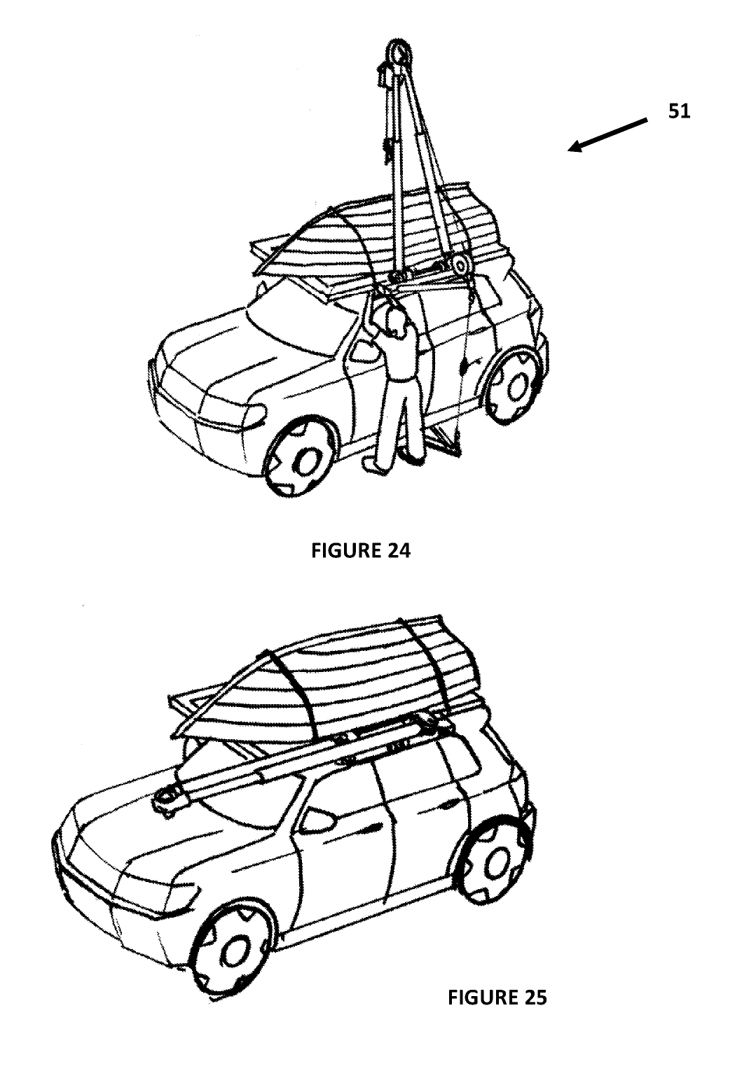

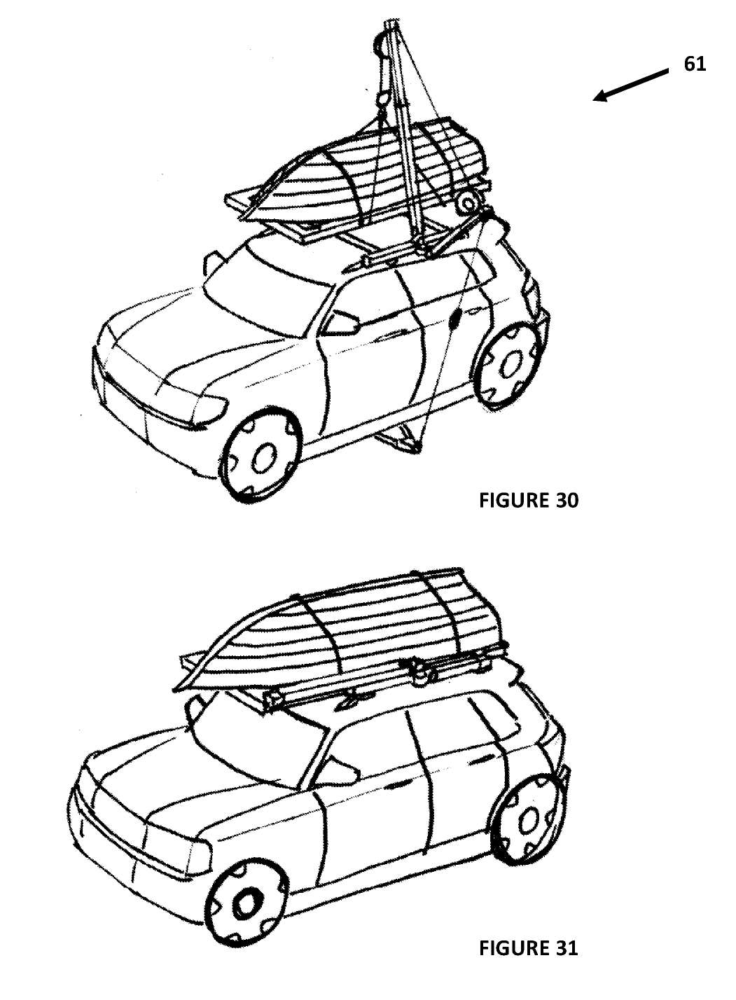

As shown in FIGS. 18 to 31 there is the lifting apparatus 51 or 61 mounted on the vehicle 15. These forms have the particular advantage of the lifting apparatus 51 or 61 being transportable with the vehicle but being usable while still connected to the vehicle. The vehicle being movable with the lifting system and the load. However it also has the advantage of being formed as a structure that can be transformed from an operative expanded form with structural integrity and capabilities to lift a load onto the vehicle to a storage and reduced form which is readily able to be transported with the load and vehicle and used at the other end of the transport trip to allow demounting of the load.

One embodiment of Version b) is the two arm lifting version 51 as shown in FIGS. 18 and 20 to 25.

The lifting version 51 lift tray has the two arms 52 connected to a vehicle lift mount 50 which forms the base of a triangular arrangement with the two arms 52 and is connected to at least part of the top of the vehicle 15. The point of the triangular arrangement is connection 54 from which a lift cable 55 can extend. The lifting arms 52 supports a lift cable 55 connectable to the lift tray 21 for supporting the load 10. The two lifting arms 52 extends from pivot support 52A and 52B on one side of the lift tray 50 to beyond the other side of the vehicle.

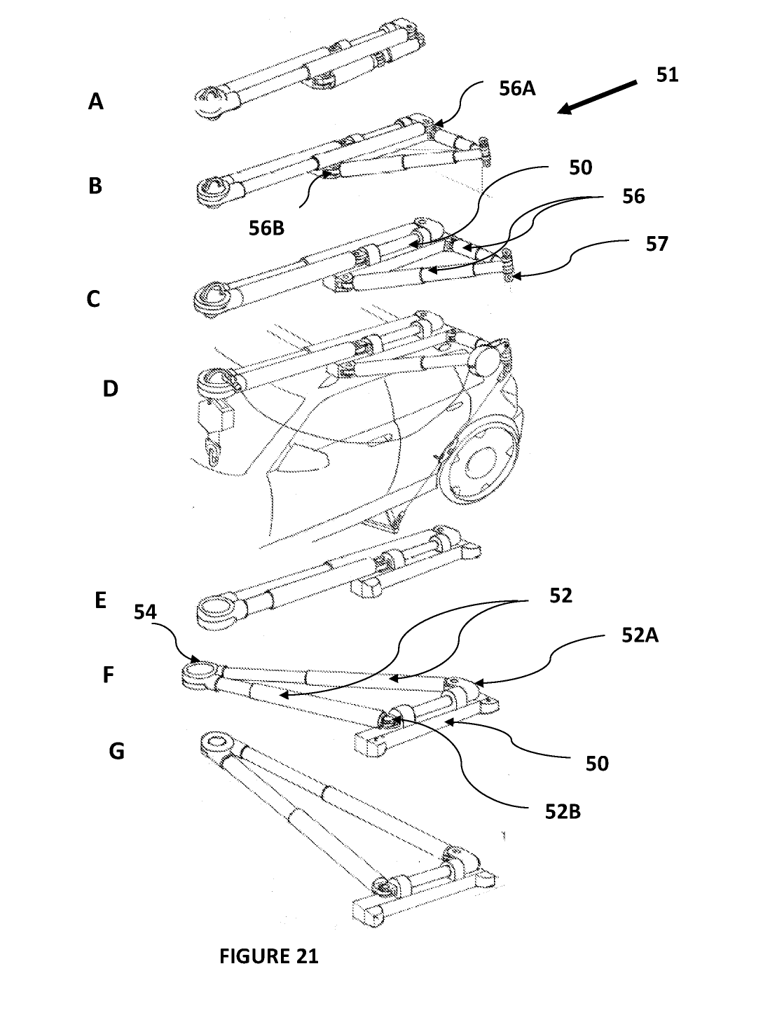

Due to the telescopic nature of the inverted V lifting arms 52 there would not be a consistent angles at the vertex between the two telescopic legs if the two legs remained of similar length and an isosceles triangle existed. This would need an alterable connection at the vertex 54 of the telescopic legs 52. However another option as shown particularly in detail F of FIG. 21 has the pivotal connections 52A and 52B with a first pivotal connection to the base 50 of the vehicle by both legs connected to ends of pivot bar extending parallel to the side support 50 and thereby the inverted V pivoting normal to the side support 50. The pivotal connections 52A and 52B includes a second pivotal connection with an overhanging pivot at one end and a standard pivot at the other allowing pivoting in the plane of the side support 50. This allows for the telescopic legs to be different length and the triangle of the inverted V to be slightly altered from an isosceles triangle. However both forms of leeway can be used.

The two arm lifting version 51 further includes two telescopic legs 56 forming a pivot brace which another but smaller inverted V shape is extending in opposite direction to the inverted V of the two overhanging telescopic lifting arms 52. These other two telescopic arms 56 are joined to the side support 50 similarly to the inverted V of the two overhanging telescopic lifting arms 52 to the side support 50.

The lifting arms 52 of the two arm lifting version 51 includes a support cable 58 extending from the lift tray to the vertex of the two overhanging telescopic lifting arms 52 at or near a top portion of the pivot connection 54 and down around the oppositely protruding vertex 57 of the inverted V shape of the pivot brace 56 and extending at an angle down alongside the side of the vehicle thereto but spaced from the vehicle 15 in use. A counter weight or base 59A can be ground engaging and extend under the vehicle connected to the support cable 59B. The support cable 59B can be used to retain the vertex 57 of the pivot brace 56 stable to provide support by the overhanging support cable 58 of the end 54 of the two overhanging telescopic lifting arms 52.

The lifting cable 55 further includes a lift pulley for aiding the user to lift the load 10 with the lifting apparatus 51 wherein the lift pulley extends to an upper part of the lift arm 52 of the lifting apparatus and includes a pulley arrangement to provide a mechanical aid.

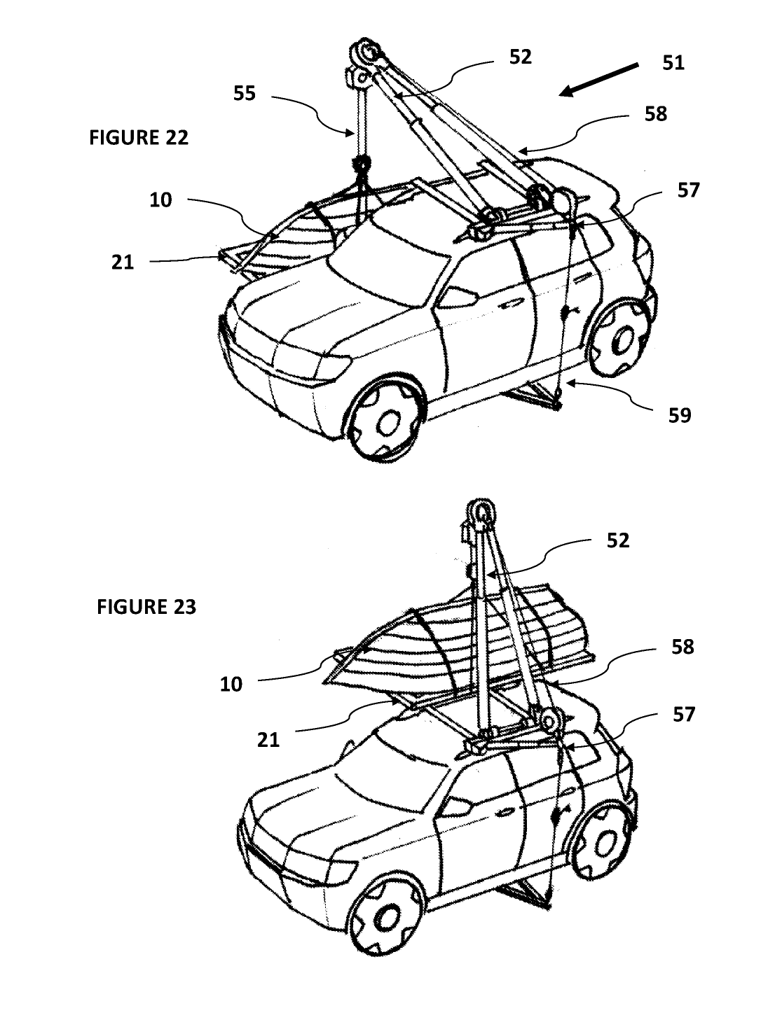

As shown in FIGS. 22 to 25, this allows the lifting arm to extend alongside the opposite side of the vehicle and engage the ground to self-support the lift tray and allow the lift tray to receive a load in a consistent vertical orientation and allow the lifting arm to lift the load from the lower position in the consistent vertical orientation to the raised position at or above the vehicle roof and to be supported on the vehicle in the same consistent vertical orientation.

FIG. 21 further shows the storability of the lifting apparatus 51 of FIGS. 18 and 20 to 25. In particular detail D shows the lifting apparatus including a lift cable 55 has the lift cable mounted on a lift cable support mounted to the vehicle and movable from a storage position on the vehicle to an operative position on the vehicle. Details E, F and G show the foldability of the inverted V of the two overhanging telescopic lifting arms 52. The pivot arm 52 and pivot brace 56 have further hinge means 52A and 52B and 56A and 56B to allow folding in a direction parallel to the pivot axis so that the pivot arm 52 and pivot brace 56 fold in a longitudinal direction along the vehicle. In this way the lifting apparatus takes minimum storage space and is readily transportable with the load 10 on the vehicle roof supports 11.

Another embodiment of Version b) is the single arm lifting version 61 shown in FIGS. 19 and 26 to 31. This is substantially similar to the two arm lifting version 51 as shown in FIGS. 18 and 20 to 25 but is substantially simpler.

The base 60 of the single arm lifting version 61 forms at least part of the vehicle 15 and at the other end 64 can suspend a lift cable 65 which supports the vehicle roof mounted supporting lift tray 21 that holds the load and which is lifted and supported on the vehicle 15. The lifting arm 62 supporting the lift cable 65 connectable to the lift tray 21 can have a single overhanging telescopic lifting arms 61 connected pivotally at one end to the base 60 on one top side of the vehicle 15 and able to extend over the other side of the vehicle.

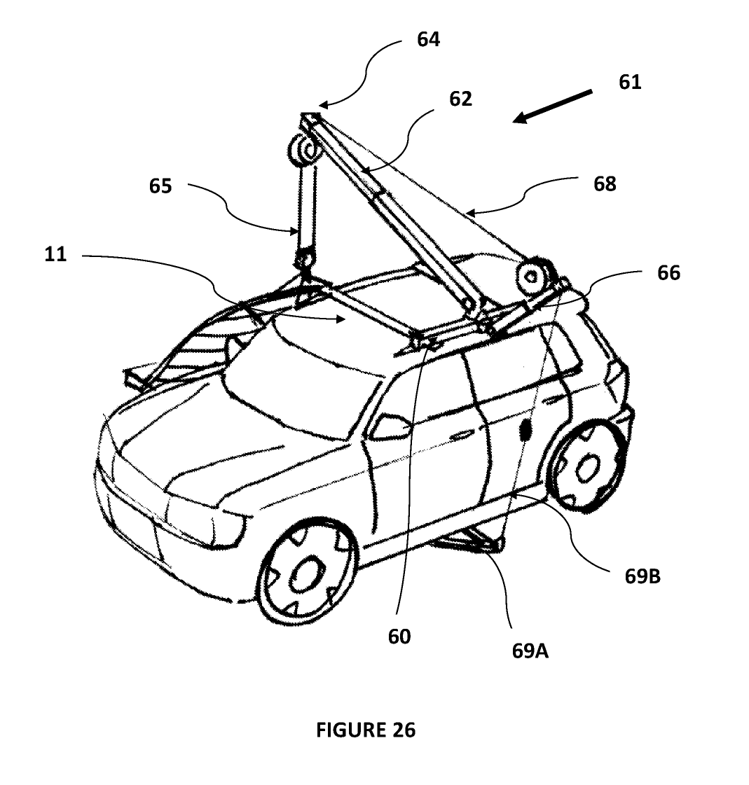

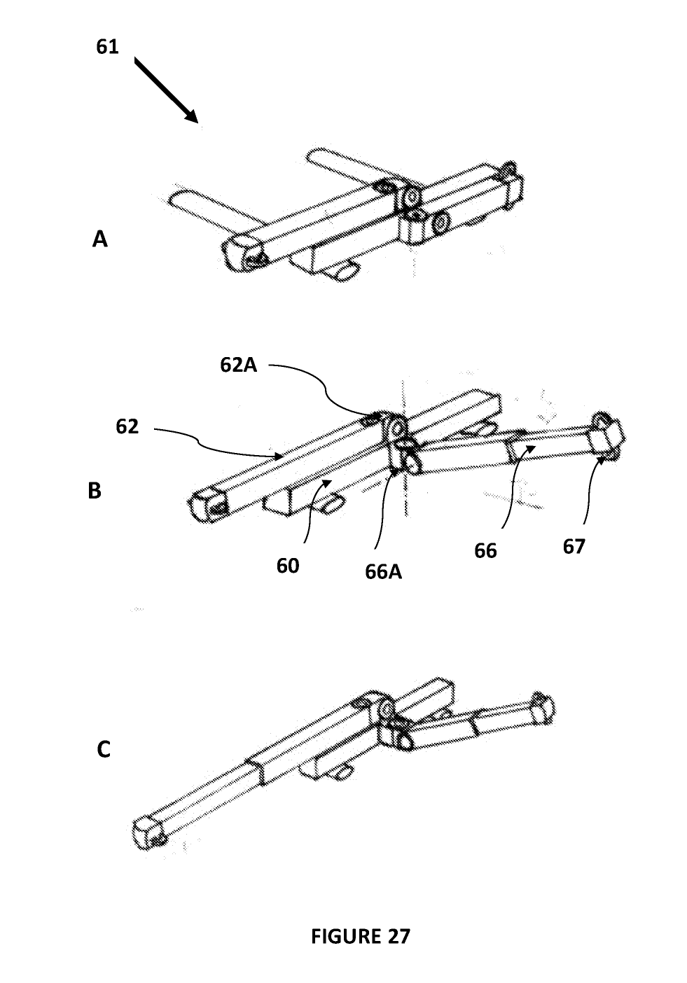

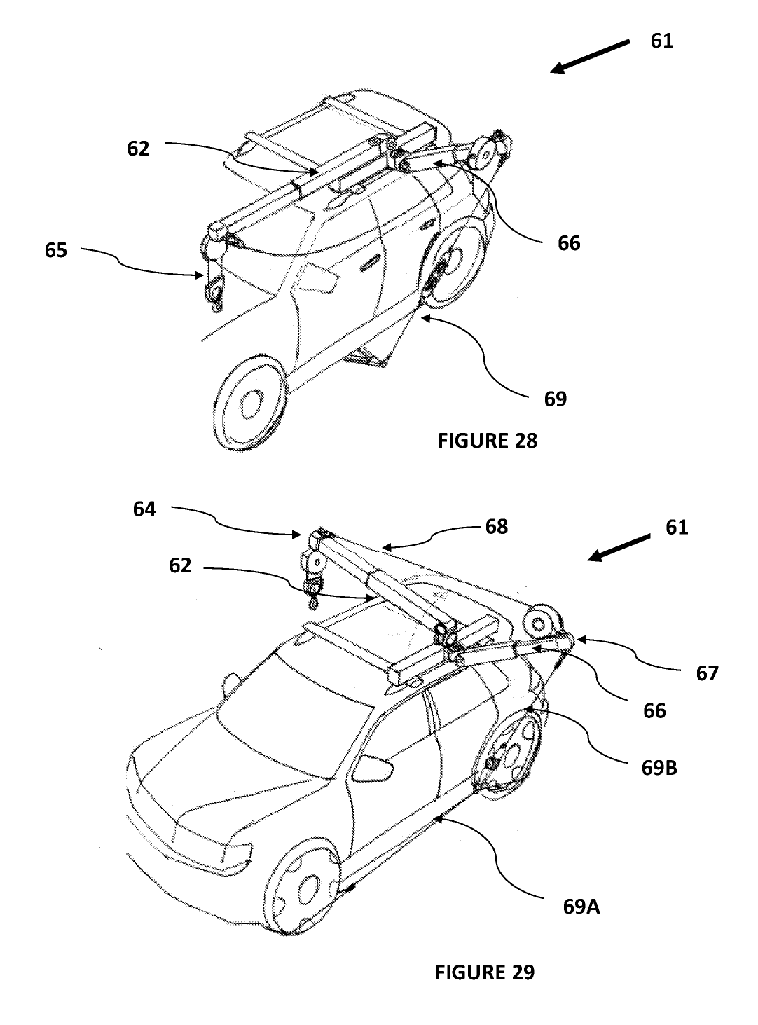

The single arm lifting version 61 further includes a single telescopic leg 66 forming a pivot brace extending in an oppositely angled direction to the single overhanging telescopic lifting arm 62. The pivot brace being in fixed position when in supporting use. The telescopic arm 62 is pivotally connected to the side support 60 to allow rotation over the roof and alter the angle to the roof as shown in comparison of FIG. 26 to FIG. 30. However telescopic arm 62 includes a second pivotal connection to allow rotation to allow substantial co-extension parallel to the side support 60 as shown in FIGS. 27 and 28.

The single telescopic leg 66 forming a pivot brace extending in opposite direction to the single overhanging telescopic lifting arm 62 has a distal point 67. A supporting overhanging cable 68 extends from this point 67 to the distal end point 64 of the single lifting arm 62 to support the load. In order to provide a counterweight or rigidity to the point 67 to effect support on the lifting arm 62 a ground lift counterweight 69 comprising a ground engaging counterweight 69A and a cable 69B extending therefrom to the support point 67.

The pivoting angle of the lifting arm 62 can be altered relative to the top of the vehicle as shown and together with the telescopic extension of the lifting arms 62 to allow variation of the suspension of the lift cable 65 alongside or over the vehicle 15. The lifting cable 65 further includes a lift pulley for aiding the user to lift the load 10 with the lifting apparatus 61 wherein the lift pulley extends to an upper part of the lifting arm 62 of the lifting apparatus and includes a pulley arrangement to provide a mechanical aid.

As shown in FIGS. 28 to 31, this allows the lifting arm to extend alongside the opposite side of the vehicle and engage the ground to self-support the lift tray and allow the lift tray to receive a load in a consistent vertical orientation and allow the lifting arm to lift the load from the lower position in the consistent vertical orientation to the raised position at or above the vehicle roof and to be supported on the vehicle in the same consistent vertical orientation.

FIG. 27 further shows the storability of the lifting apparatus 61 of FIGS. 18 and 20 to 25. In particular details A, B and C folding in a direction parallel to the pivot axis so that the pivot arm 62 and pivot brace 66 fold around pivot connections 62A and 66A in a longitudinal direction along the vehicle. In this way the lifting apparatus takes minimum storage space and is readily transportable with the load 10 on the vehicle roof supports 11.

Referring to FIG. 29 the lifting counterweight base 69 can be provided by cabling 69A around the vehicle wheels so that the vehicle provides the counterweight base to the support point 67 through the in-between cable 69B. Such a system can form the base of any of the systems.

Version c)

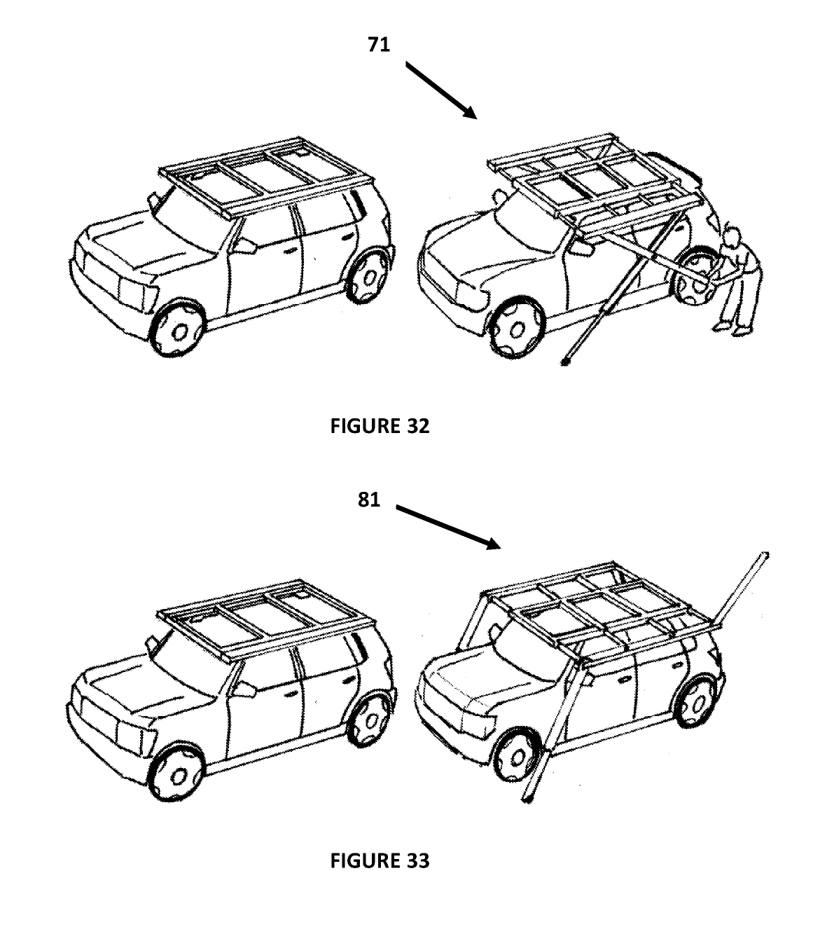

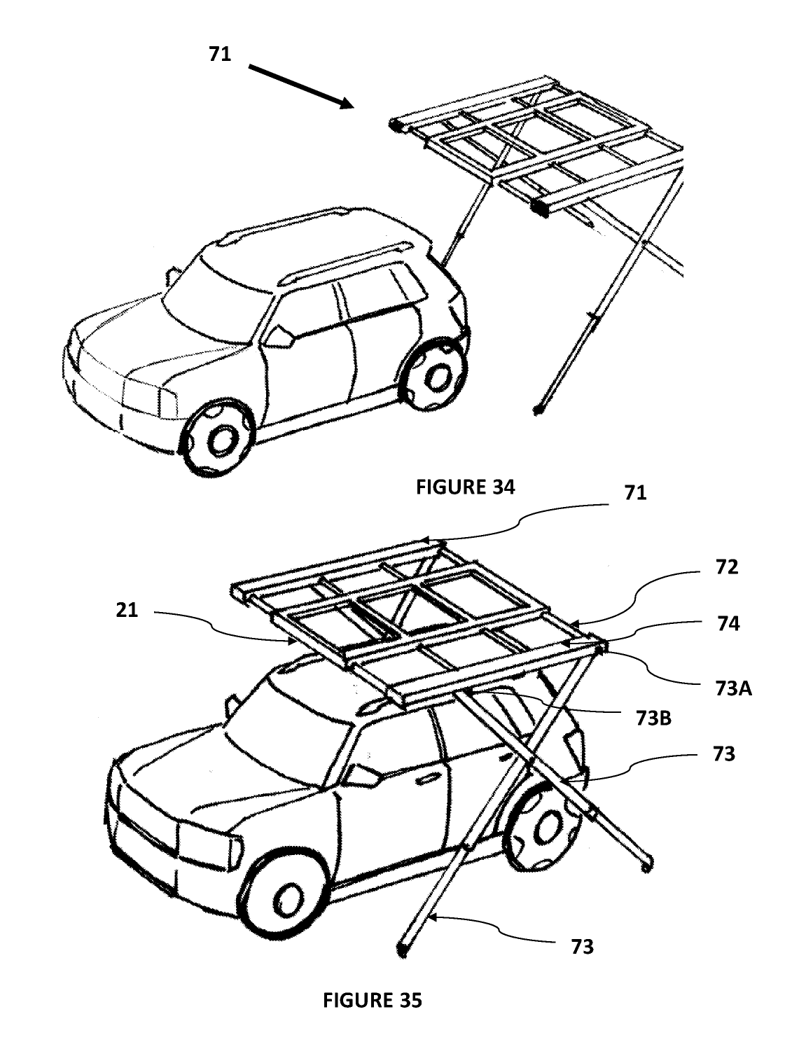

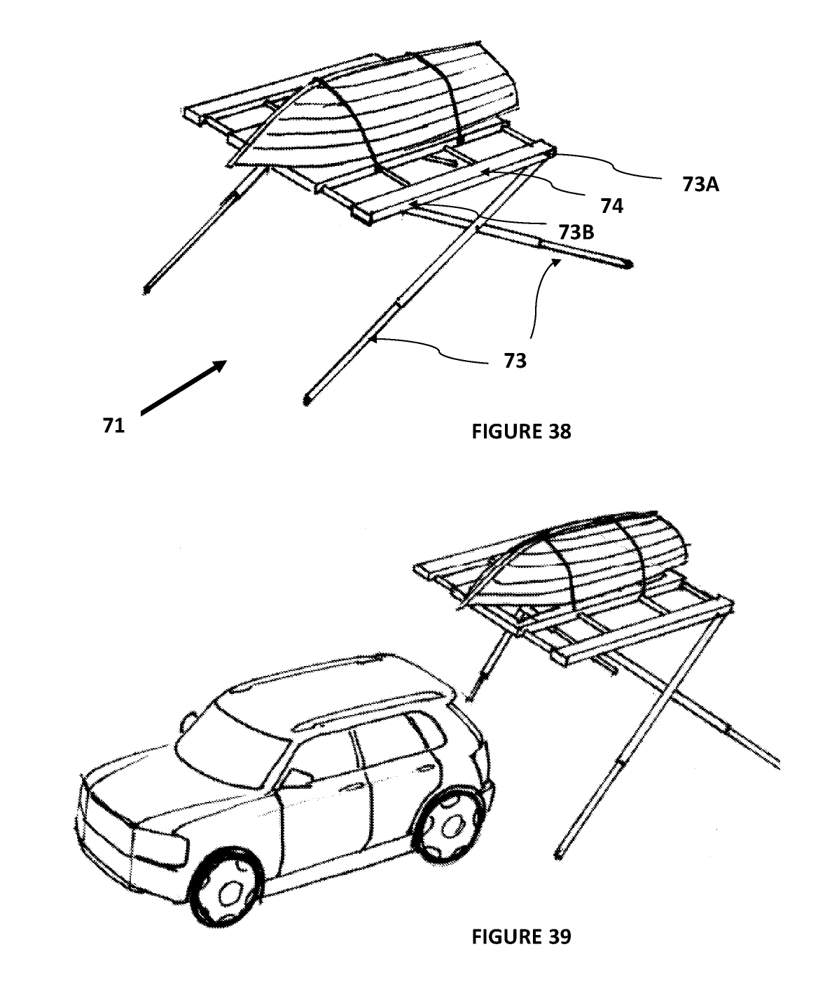

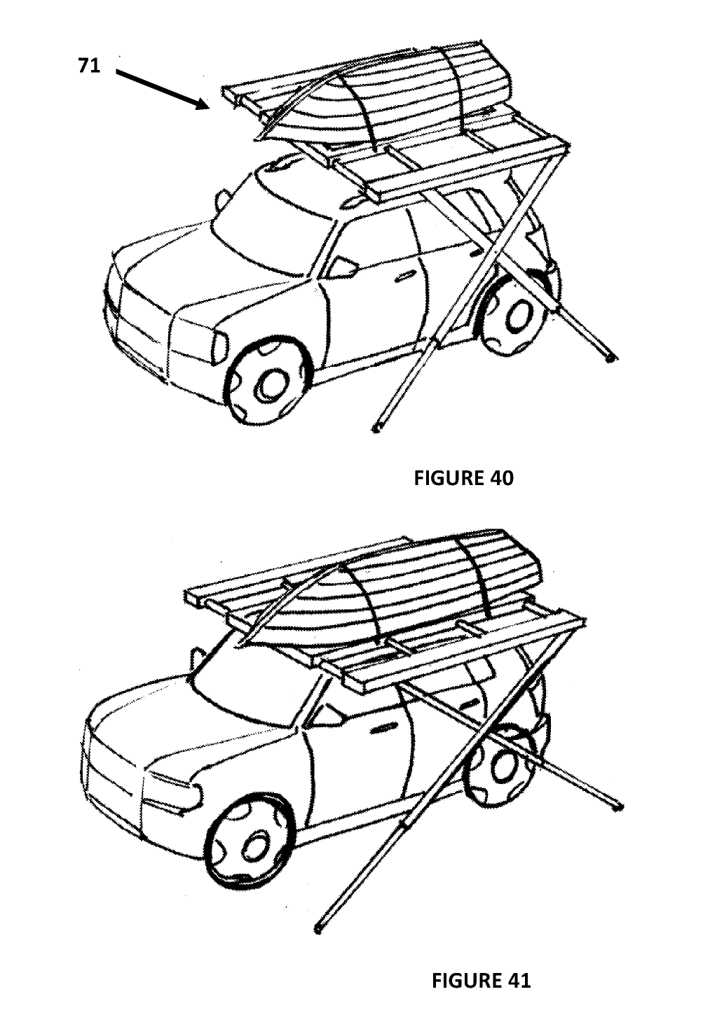

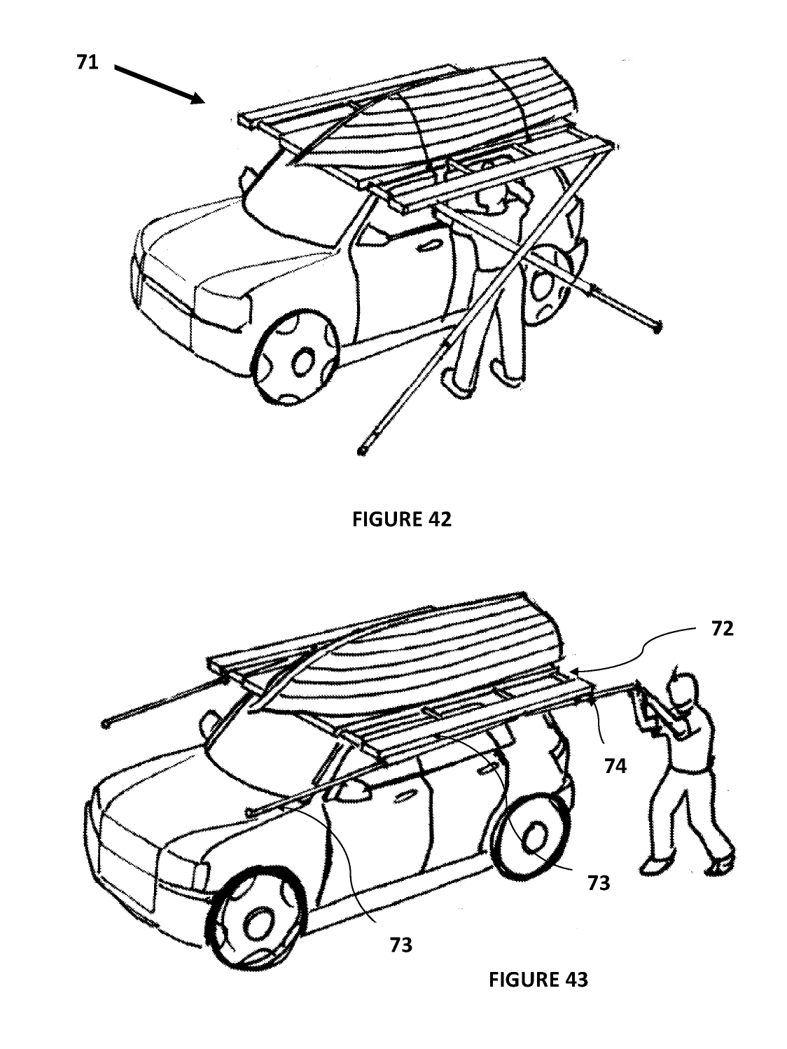

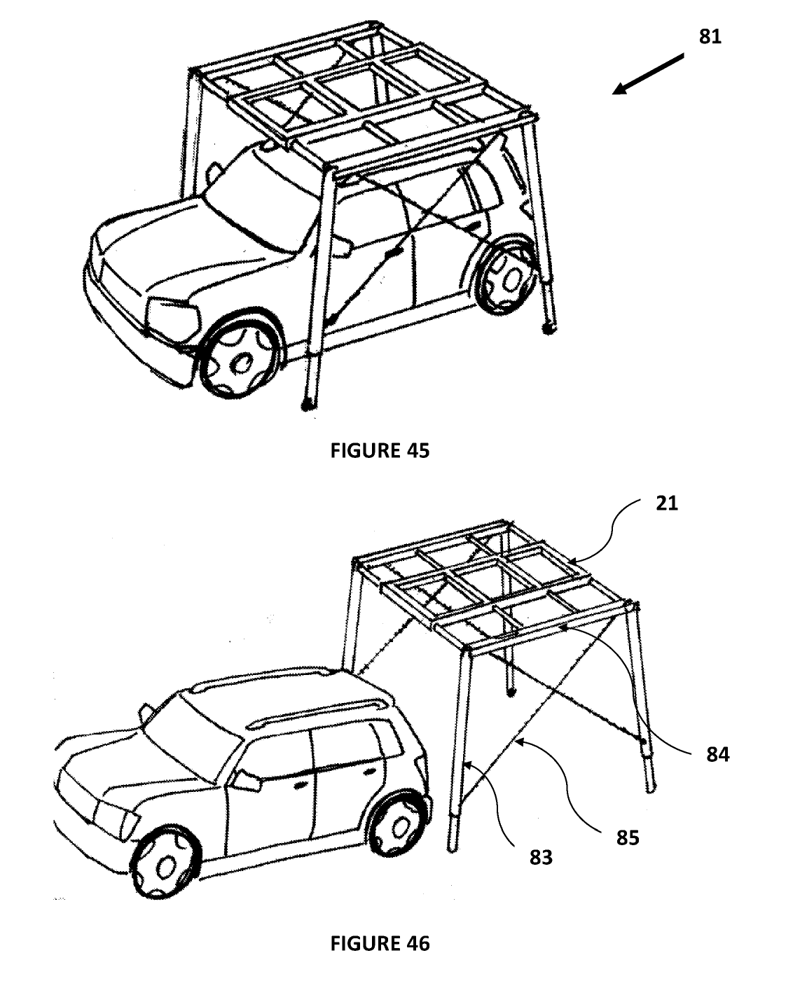

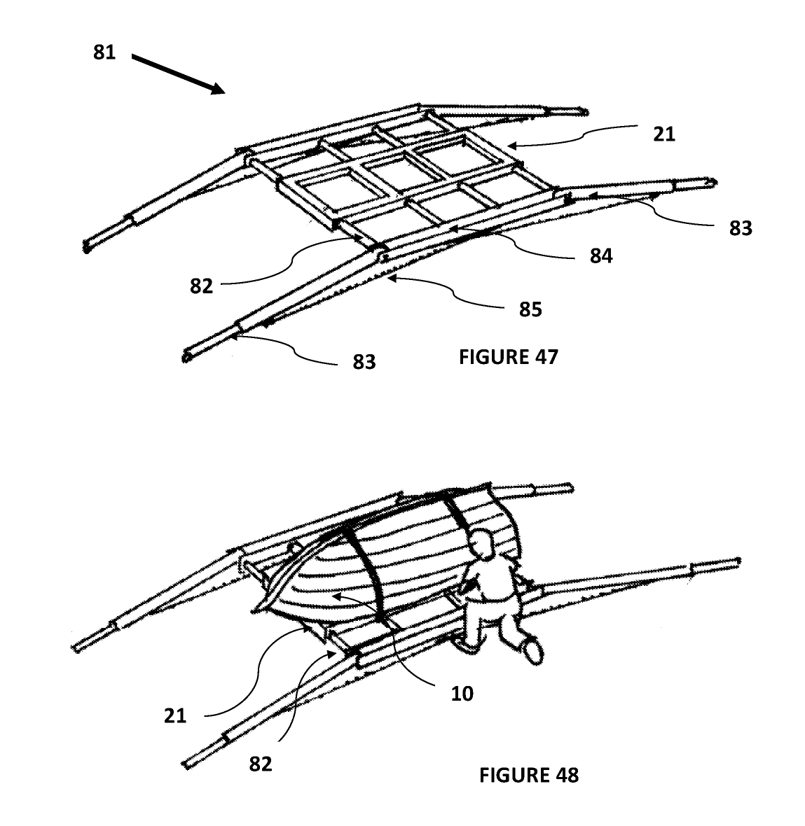

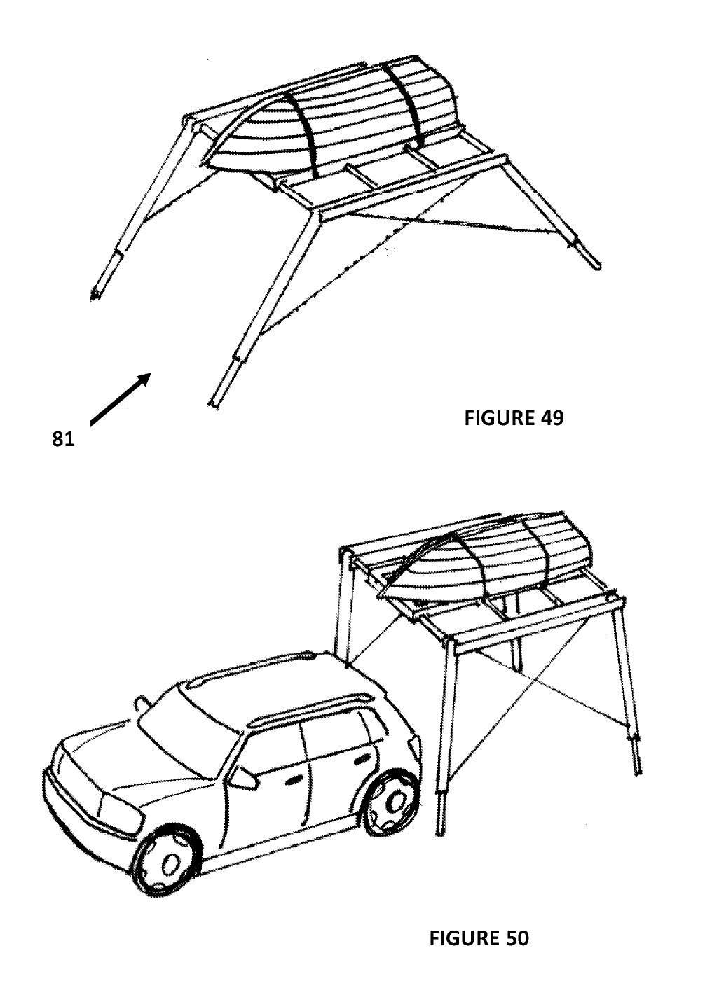

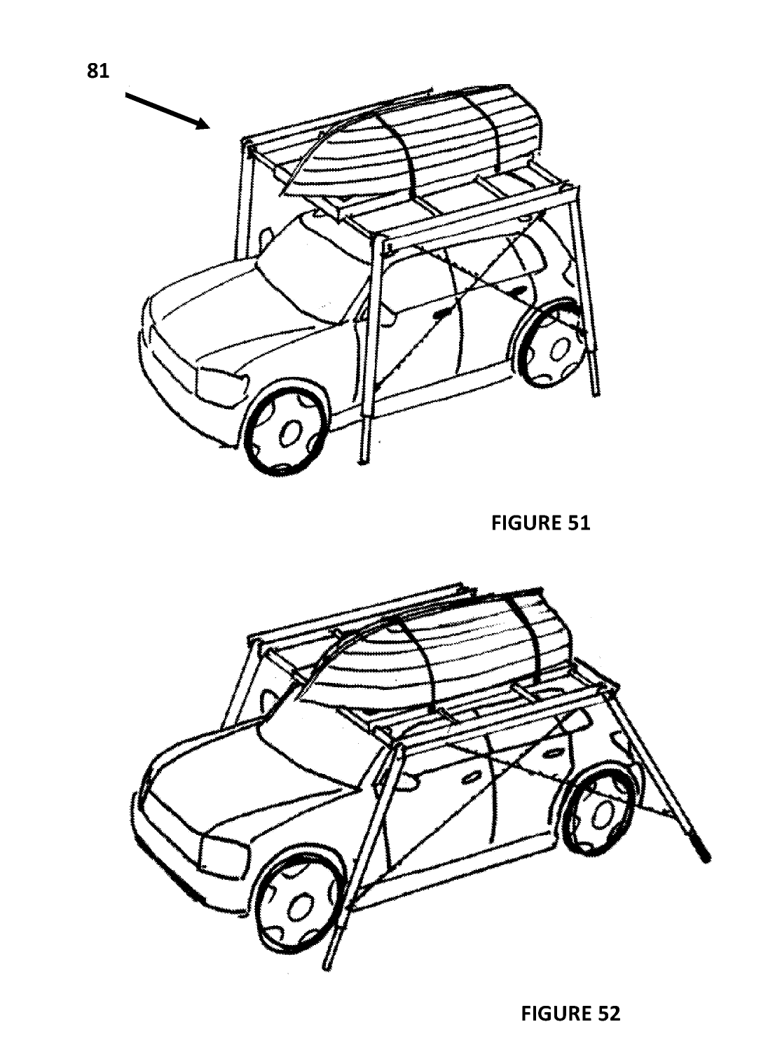

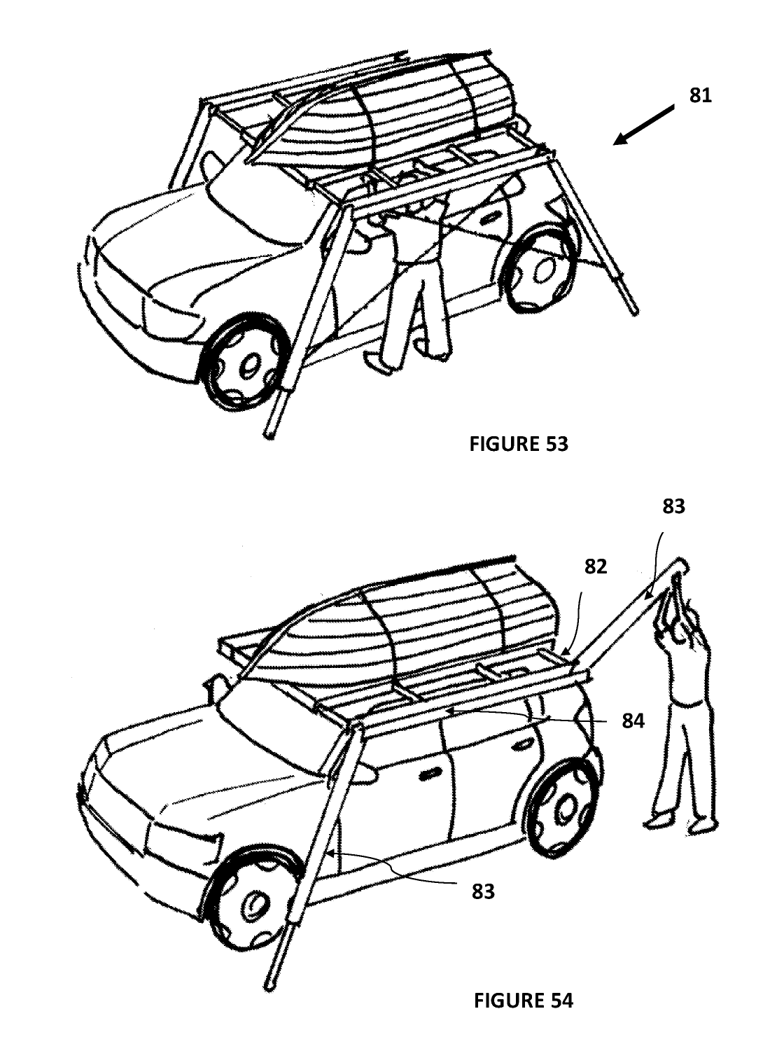

Referring to FIGS. 32 to 54 there is shown a leg extension versions 71 and 81 of the lifting apparatus. The vehicle roof mountable supporting lift tray 21 can hold the load 10 and is supportable on the vehicle 15. These leg extension versions 71 and 81 of the lifting apparatus have the particular advantage of the lifting apparatus 71 or 81 being transportable with the vehicle but being attachable and detachable to the vehicle. The vehicle being movable with the lifting system and the load. However it also has the advantage of being formed as a structure that can be transformed from an operative expanded form with structural integrity and capabilities to lift a load onto the vehicle to a storage and reduced form which is readily able to be transported with the load and vehicle and used at the other end of the transport trip to allow demounting of the load.

One embodiment of Version c) is the scissor lifting version 71 shown in FIGS. 32 and 34 to 43. Another embodiment of Version c) is the tensioned telescopic leg version 81 shown in FIGS. 33 and 44 to 54

The lifting legs 73 extend from side rails 74 that can be extended laterally from the lift tray 21 by lateral extensions 72. The lifting legs 73 being spaced from the body of the lift tray 21 by lateral extension 72 allow the lifting legs 73 to extend alongside the sides of the vehicle 15. The lift tray 21 can then be supported by the ground engaging lifting legs 73.

The lifting legs 73 can use a scissor lifting arrangement and can use a hydraulic lifting arrangement. However as shown in the Figures the lifting legs use a cross leg system with the lifting legs using a telescopic legs lifting arrangement. In particular the side rails 74 can capture the top 73A, 73B of the legs 73 with one being held in position while the other can slide. This will affect the angle of intersection of the scissor configuration legs 73 and result in alteration of the height of the lift tray 21.

In loaded position on the vehicle the lift tray 21 the side rails 74 can be laterally extended by lateral extension 72 from the lift tray 21 and then the legs 73 released downwards from the side rails 74. The lifting legs extend from leg extension support on opposite sides alongside the sides of the vehicle and engage the ground to self-support the lift tray 21 and the load 10 thereon and allow the vehicle 15 to move relative the load carrier.

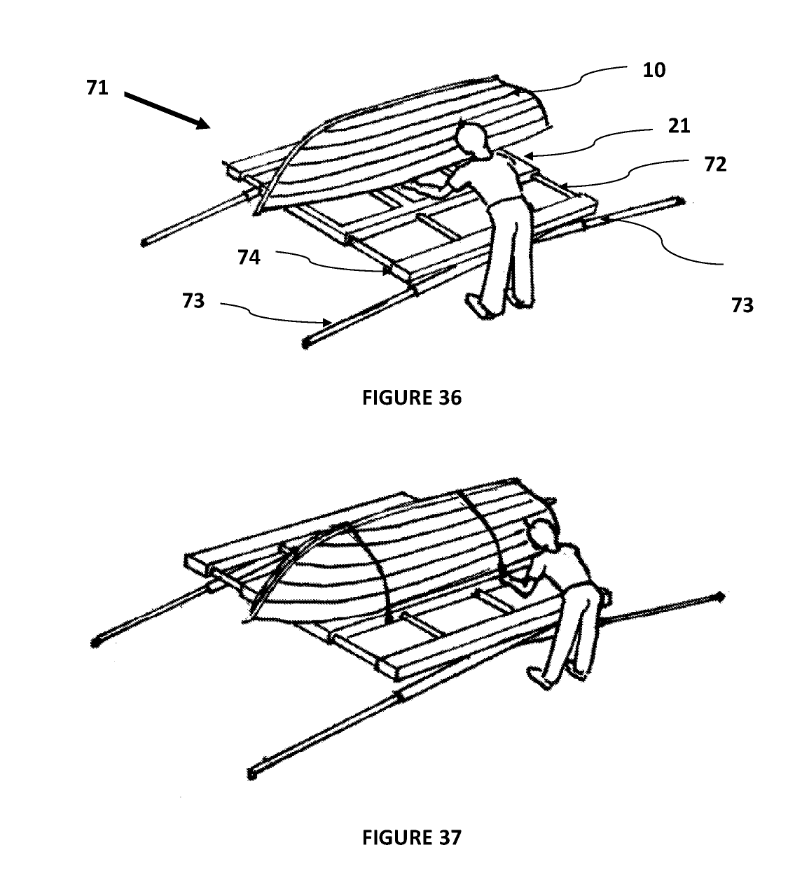

The lifting legs 73 can then have a captured top 73A, 73B of the legs 73 slide within the side rails 74 to affect the angle of intersection of the scissor configuration legs 73 and result in lowering of the height of the lift tray 21 and load to a ground position as shown in FIGS. 36 and 37.

Therefore the system allows a single person to retract and lower the lift tray 21 and load 10 thereon to the lower position to receive a load in a consistent vertical orientation and allow the lifting legs to lift the load from the lower position in the consistent vertical orientation to the raised position at or above the vehicle roof and allow the vehicle to move relative the load carrier to allow the load to be lifted in the consistent vertical orientation and supported on the vehicle in the same consistent vertical orientation.

In the embodiment of the tensioned telescopic leg version 81 shown in FIGS. 33 and 44 to 54 there is a lift tray 21 for supporting the load 10 on legs 83 mounted pivotally to side rails 84 that extend from the lift tray 21 by lateral extensions 82. The side rails 84 are laterally extendable from the lift tray 21 so the legs can extend alongside the vehicle.

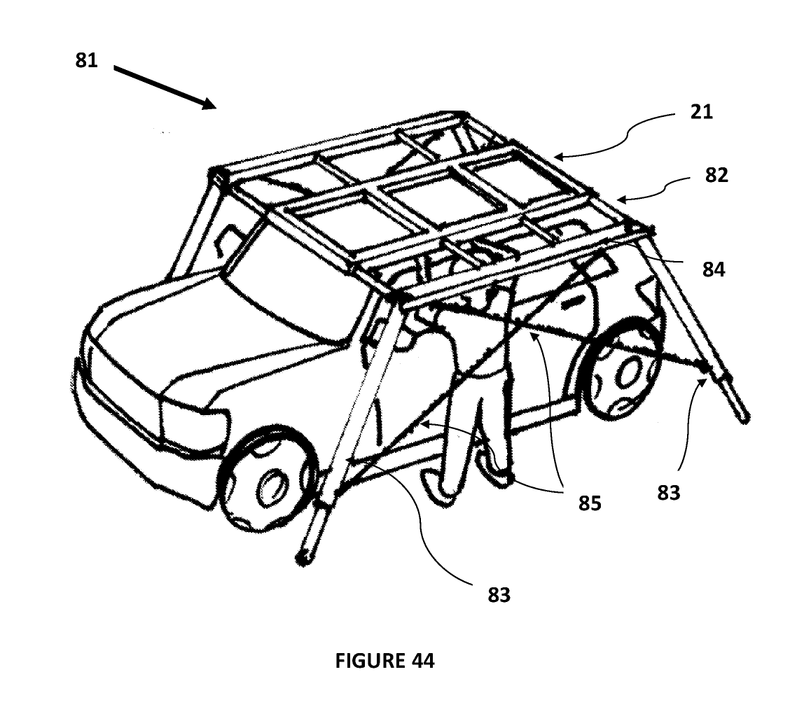

Each pair of legs 83 extend from opposite ends of the side rail 84 and splay outwards along the side of the vehicle. To limit the splay there is a set of cross over support cables 85 extending from a low point of a leg 83 to a high point on the other leg 83 on that side or to the nearby portion of the side rail 84. The pivoting legs are controlled in their splaying to affect the angle of splaying of the legs 83 and result in lowering or raising of the height of the lift tray 21 as shown in comparison between FIG. 44 to 46 to 47.

As shown in FIG. 43 after mounting the load on the lift tray 21 onto the vehicle 15 the lifting means 81 can have the legs 83 pivotally rotate into the side rails 84 and these can be retracted back to substantially the width of the lift tray to allow ready travel with the vehicle and dismount of the loads with the lifting means 81 at the other end of the trip.

Version d)

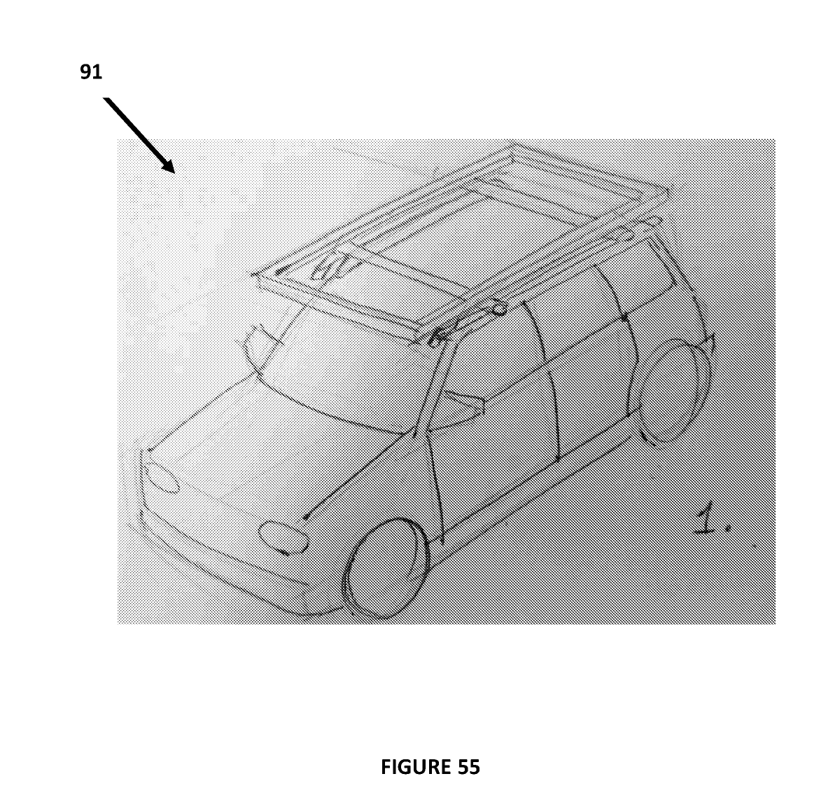

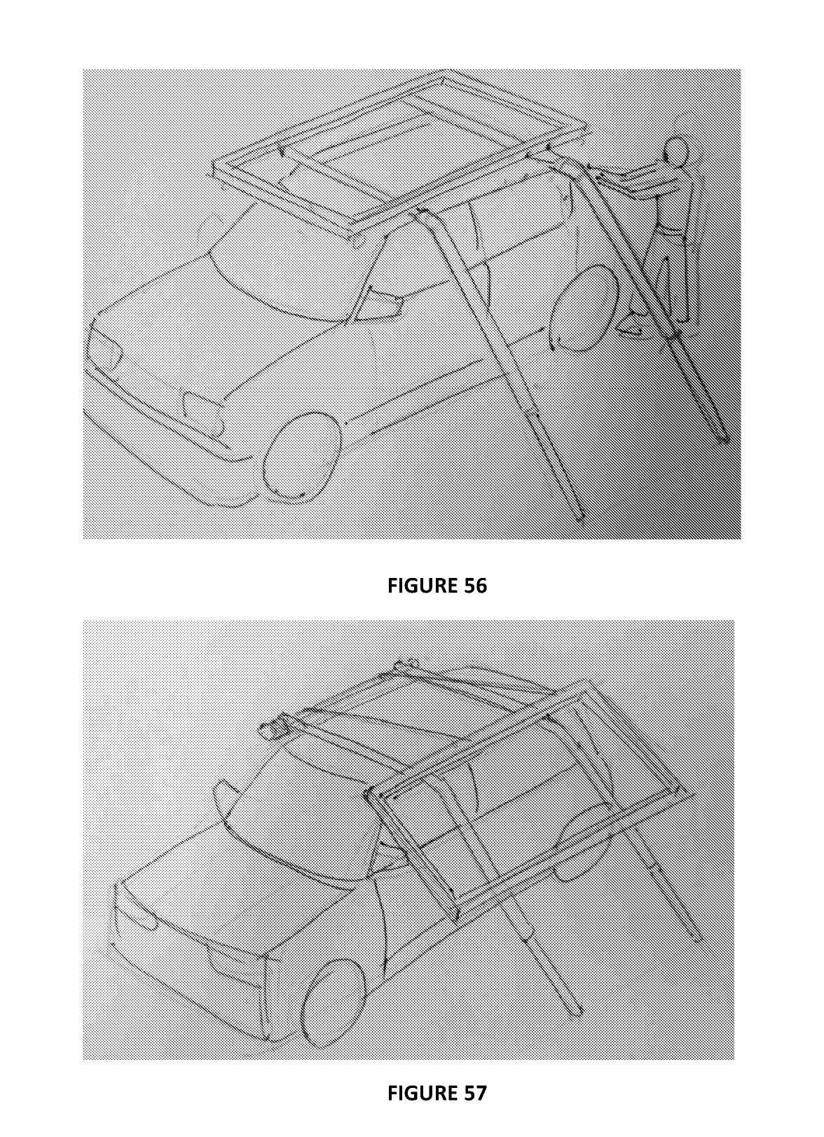

Referring to FIGS. 55 to 57 there is shown a load carrier for a vehicle according to claim 1 further comprising a lift slide and lift pulley for aiding the user to lift a load with the lifting apparatus wherein the lift slide is extendable from a transport mode to a loading and unloading mode and extends from the vehicle roof mounts towards the ground adjacent to the vehicle and the lift pulley mounted on the vehicle and attached to the lifting frame allows selective control of the lifting frame to slide from a loaded position on the vehicle roof mounts along the lift slide to an unloaded position adjacent the vehicle.

Interpretation Load

Throughout this document including the claims the term “Load” is to refer to a item to be transported by a vehicle, and can be combined on a base such as a lift tray, or a container having a base that can contain a load. It also refers to multiple items that can be handled and stored on a single base. However the load is to have an identified “vertical orientation” such that the load is retainable in a consistent vertical orientation. This includes prevention of tilting and leaning by properly securing of load to the base such as the lift tray.

### EMBODIMENTS

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the accessories for primarily domestic motor vehicle industries.

What is claimed is:

1. A load carrier for a vehicle comprising
i. a vehicle roof supports adapted to carry a load thereon in a consistent vertical orientation;
ii. a lifting apparatus for lifting the load from a lower position in the consistent vertical orientation to a raised position at or above the vehicle roof supports;
iii. the lifting apparatus having a lift mount, wherein the lift mount is able to proceed from the lower position and extend above the vehicle roof supports to a raised position to allow mounting of the load is able to be lifted in the consistent vertical orientation and supported in the same consistent vertical orientation
iv. a lift tray supported by the lift mount and upon which the load can be mounted on the ground and the load is able to be lifted to the raised position at or above the vehicle roof supports in the consistent vertical orientation and supported in the same consistent vertical orientation.
wherein the load is able to be lifted substantially in a consistent vertical orientation, relative to the lift tray, and supported in the same consistent vertical orientation, relative to the lift tray.

2. (canceled)

3. A load carrier for a vehicle according to claim 1 further comprising the lifting mount having a lifting arm;
wherein the lifting arm is able to pivot around a pivot support and extend from a lower pivot position to a high pivot position above the raised position wherein the load is able to be lifted in the consistent vertical orientation and supported in the same consistent vertical orientation,

4. A load carrier for a vehicle according to claim 1 further comprising the lifting mount having lifting legs,
wherein the lifting legs are able to extend from a leg extension support and extend from a lower leg extension position to a high leg extension position above the raised position wherein the load is able to be lifted in the consistent vertical orientation and supported in the same consistent vertical orientation.

5. A load carrier for a vehicle according to claim 1 wherein the lifting apparatus includes a lift cable;
wherein the lift cable is able to extend from a lift cable support and extend from a lower cable extension position to a high cable extension position above the raised position wherein the load is able to be lifted in the consistent vertical orientation and supported in the same consistent vertical orientation.

8. (canceled)

7. (canceled)

8. (canceled)

9. (canceled)

10. (canceled)

11. (canceled)

12. A load carrier for a vehicle according to claim 5 wherein the lift mount includes a foldable mount structure having a releasable locking means for allowing locking of the foldable mount structure in an operating condition, and release to a folded storage position upon release of the locking means.

13. (canceled)

14. A load carrier for a vehicle according to claim 12 wherein the lifting mount having a lifting arm is pivotally mounted on pivot support mounted to the vehicle and movable from a storage position on the vehicle to an operative position on the vehicle and wherein the lifting arm in an operative position pivots in a first direction from the pivot support and the lifting arm pivots in a second direction separate to the first direction to a storage position which is alongside the vehicle roof supports.

15. (canceled)

16. A load carrier for a vehicle according to claim 1 wherein the lifting apparatus interacts with the vehicle and includes at least part of the lifting apparatus mountable on the vehicle to assist the lifting operation by forming a leveraging base to allow the load to be counterbalanced by the vehicle.

17. (canceled)

18. (canceled)

13. (canceled)

20. A load carrier for a vehicle according to claim 1 further comprising the lifting mount having lifting legs, wherein the lifting legs are extendable from a leg extension support and separately supportable in relation to a vehicle from a storage position to an operative position.

21. (canceled)

22. A load carrier for a vehicle according to claim 20 wherein the lifting legs use a scissor lifting arrangement.

23. (canceled)

24. (canceled)

25. (canceled)

26. (canceled)

27. (canceled)

28. (canceled)

29. (canceled)

30. A load carrier for a vehicle according to claim 1 further comprising a lift slide and lift pulley for aiding the user to lift a load with the lifting apparatus wherein the lift slide is extendable from a transport mode to a loading and unloading mode and extends from the vehicle roof mounts towards the ground adjacent to the vehicle and the lift pulley mounted on the vehicle and attached to the lifting frame allows selective control of the lifting frame to slide from a loaded position on the vehicle roof mounts along the lift slide to an unloaded position adjacent the vehicle.

31. (canceled)

32. (canceled)

33. (canceled)

34. (canceled)

35. (canceled)

36. (canceled)

37. (canceled)

38. A load carrier for a vehicle comprising
i. a vehicle roof supports adapted to carry a load thereon in a consistent vertical orientation;
ii. a lifting apparatus for lifting the load from a lower unloaded position in the consistent vertical orientation to a raised loaded position at or above the vehicle roof supports;
iii. a lifting frame for supporting the load when in the loaded position from the unloaded position;
iv. a lifting frame movement means which lifts the lifting frame between the loaded position and the unloaded position
wherein the load is able to be lifted in the consistent vertical orientation and supported in the same consistent vertical orientation
and wherein the lifting apparatus is transportable with the vehicle.

39. (canceled)

40. A load carrier for a vehicle according to claim 38 wherein the lifting apparatus is mounted to the vehicle so as to be transportable with the vehicle and to be operable as a lifting apparatus while mounted to the vehicle.

41. (canceled)

42. (canceled)

43. (canceled)

44. A load carrier for a vehicle according to claim 38 wherein the lifting frame movement means is provided by a lift mount is mountable on the ground.

45. (canceled)

46. A load carrier for a vehicle according to claim 38 wherein the lifting frame movement means is provided by lift mount which is mounted on the vehicle roof supports.

47. A load carrier for a vehicle according to claim 38 wherein the lifting frame movement means is provided by a lift mount which includes a foldable mount structure having a releasable locking means for allowing locking of the foldable mount structure in an operating condition, and release to a folded storage position upon release of the locking means

48. (canceled)

49. A load carrier for a vehicle according to claim 38 wherein the lifting frame movement means is provided by lifting legs which use a scissor lifting arrangement.

50. (canceled)

51. (canceled)

52. A load carrier for a vehicle according to claim 38 wherein the lifting frame movement means is provided by lifting legs which are operable to retract and lower the lift tray to the lower position to receive a load in a consistent vertical orientation and allow the lifting legs to lift the load from the lower position in the consistent vertical orientation to the raised position at or above the vehicle roof and allow the vehicle to move relative the load carrier to allow the load to be lifted in the consistent vertical orientation and supported on the vehicle in the same consistent vertical orientation.

53. A load carrier for a vehicle according to claim 38 wherein the lifting frame movement means is provided by a lifting apparatus including a lift cable has the lift cable mounted on a lift cable support separate to the vehicle and movable in relation to a vehicle.

54. A load carrier for a vehicle according to claim 38 wherein the lifting frame movement means is provided by a lift pulley for aiding the user to lift load with the lifting apparatus wherein the lift pulley extends to an upper part of the lift arm of the lifting apparatus and includes a pulley arrangement to provide a mechanical aid.

55. A load carrier for a vehicle according to claim 38 wherein the lifting frame movement means is provided by a lift slide and lift pulley for aiding the user to lift a load with the lifting apparatus wherein the lift slide is extendable from a transport mode to a loading and unloading mode and extends from the vehicle roof mounts towards the ground adjacent to the vehicle and the lift pulley mounted on the vehicle and attached to the lifting frame allows selective control of the lifting frame to slide from a loaded position on the vehicle roof mounts along the lift slide to an unloaded position adjacent the vehicle.
